(19) United States
(12) Patent Application Publication
(10) Pub. No.: US 2008/0046222 A1
(43) Pub. Date: Feb. 21, 2008

(54) Copyright of Digital Works in a Virtual Environment

(75) Inventor: Andrew Stephen Van Luchene, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/620,563

(22) Filed: Jan. 5, 2007

Related U.S. Application Data
(63) Continuation-in-part of application No. 11/428,263, filed on Jun. 30, 2006.

(51) Int. Cl. G06G 7/48

(52) U.S. Cl. 703/6

(57) ABSTRACT

The present disclosure provides various novel concepts to a video game environment. Video game environments that include a method for controlling the quantity of raw materials in and between games, where player characters invent items by creating blueprints that are registered to a virtual patent office and used by other player characters, that include methods for digital rights management, that include a method for providing inter and intra game exchanges between games, and that provide for the Initial Public Offering of game environments on an Inter Game Environment exchange are described.

### PRIORITY CLAIM

The following application is a continuation-in-part of U.S. patent application Ser. No. 11/428,263, “Video Game Environment” filed Jun. 30, 2006, which is hereby incorporated by reference.

### BACKGROUND

Video games which are accessible to multiple players via a server are well known. For example, hundreds of thousands of players access games known as massive multi player online games (MMOGs). Players of these games customarily access a game repeatedly (for durations typically ranging from a few minutes to several days) over given period of time, which may be days, weeks, months or even years. The games are often constructed such that players pay a periodic subscription price (e.g., $15 per month) rather than, or in addition to, paying a one time purchase price for the game. Often, though not necessarily, these games have no ultimate “winner” or “winning goal,” but instead attempt to create an enjoyable playing environment and a strong player community.

It would be advantageous to provide improved methods and apparatus for increasing the enjoyment and/or longevity of video games.

### BRIEF DESCRIPTION OF THE DRAWINGS

FIG. 1 provides an exemplary system 100 according to one embodiment of the present invention.

FIG. 2 provides an exemplary system 200 according to one embodiment of the present invention.

FIG. 3 provides an exemplary system 300 according to one embodiment of the present invention.

FIG. 4 provides an exemplary system 400 according to one embodiment of the present invention.

FIG. 5 provides an exemplary system 500 according to one embodiment of the present invention.

### DETAILED DESCRIPTION

### Definitions

Real Cash or Real Currency-money that has a real world value.

Virtual Cash or Virtual Currency-money that has a value in a virtual environment

Character Credit Score-the score given to a player based on his virtual financial behavior in a virtual environment.

Virtual Raw Material-items in a virtual environment that are inherent to the environment and that exist without virtual labor being applied to them. Virtual Raw Materials may include objects made up of two or more other Virtual Raw Materials.

Virtual Buy Order-an order to purchase a virtual item or attribute. The order can be placed on an inter or intra game environment exchange.

Virtual Sell Order-an order to sell a virtual item or attribute. The order can be placed on an inter or intra game environment exchange.

Virtual Bid Price-the price for a virtual item or attribute that is specified by a virtual buy order.

Virtual Ask Price-the price for a virtual item or attribute that is specified by a virtual sell order.

Virtual Blueprints-virtual designs for virtual items that include information such as dimensions, materials, skills, and other virtual items or attributes that are required to assemble a virtual item specified by the blueprint. Virtual Blueprints may define virtual objects, and/or business methods, business processes, software, games, and/or definitions to create any or all of the foregoing.

Virtual Blueprint Patent-shall mean a virtual patent number assigned to a virtual blueprint

Digital Image-a virtual image that is static or moving that can be seen in a virtual game environment

Digital Song-a song that can be purchased and played in a game environment

Digital Copyright-a proof of ownership that is attached to a digital image or digital song in a game environment

In Game Patent Office-an entity in a game environment where blueprints and/or copyrights can be registered to indicate the inventor of the blueprint or copyright

Digital Patent-the registration of a virtual blueprint with a virtual patent office

Virtual IPO-the registering of a virtual asset on a virtual exchange whereby shares of the asset can be traded between characters and players

Virtual Business-an asset in a game environment that produces virtual revenues and potentially virtual profits.

Virtual Stock-a unit of ownership of a virtual business, asset, or other game attribute

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

### Description

According to one embodiment, the present invention provides a method and system for controlling the quantity of raw materials in and between massive multi online player video game environments. Accordingly, a system is disclosed to apply a set number of raw material points in a game environment. The game server or a set of player characters can allocate the raw material points to specific raw materials, and these are the materials that are available for gathering by player characters in the game environment.

According to one embodiment, once a raw material has been gathered, it can be used to build game attributes that can be sold on exchanges in the game environment and between other game environments. Raw Materials can include, but are not limited to:

1. Herbs

2. Minerals

3. Metal Ore

4. Building Supplies

5. Water

6. Food types

7. Land

8. Wood

9. Oil

According to one embodiment, raw materials can be allocated in the first stage or era of a game environment and placed in geographic areas of the game environment by player characters. Accordingly, these player characters may act as gods of the game environment.

Alternatively or additionally, different types of raw materials or certain quantities of certain raw materials can be allocated in the game environment during certain eras of the game. For example, 1000 units “Euranium” currency may become available in the “Nuclear Age” era of a game.

According to another embodiment, the number of resources available in a game environment can be based on any one or more game play variables including, but not limited to, the number of player characters in that game environment, the pace of game play, the relative price of objects constructed by one or more resources, and/or the relative demand for one or more resources. Alternatively, the number of resources available may be unlimited but purchased using real and/or virtual currency. The amount of initial and/or subsequent resources may also be determined based upon the overall effect of greater abundance or scarcity of such resources. For example, if the lack of a certain resource is determined to unfairly benefit one player or group of players over another player or group of players, then additional resources may be made available generally (i.e., to all players on an equal or unequal basis) and/or only to those at the disadvantage, and/or if newer players join a game that has been in progress for some time, and certain resources have been either depleted or are scarce or are higher priced, then the newer player(s) may be granted such items, and/or provided the resources at a lower price and/or may be distributed randomly or otherwise in the game space but only accessible to such new players (either randomly or via performing some skill, and/or through searching or exploring territory and/or buying land that contains such resources (whether known or unknown), etc. The number of resources available per player character or other game play variable can increase sequentially or exponentially or in any other manner including pre-established supply levels for each era, game, or multiple games, or by voting from game owners or members, and/or by majority or supermajority voting, or by purchasing resources from other games that practice an embodiment of the present invention, or through the recovery of part or all of the raw materials through recycling “older” goods created during game play.

According to yet another embodiment, attributes and resources between game servers may be uniform to one another or may be exchanged using multipliers to recognize differences in supply or demand and/or exchange rates in or between one, two or more game environments. Enablement of such transfers and/or communications may be provided via any network communications and/or using technology. They are either identical like UCC or in ratios like 200 lumber in a first game may be worth 230 lumber in a different, second game. The size of player characters and game attributes must also be converted or uniform. Conversion rates may be established or modified through open markets and/or controlled by user groups or any other duly authorized body established for such purposed, which may be or include any one or more of: a) the game manufacturer(s), b) the owners of such exchanges, c) the owners of the systems and applications that provide or support such exchanges, d) one or more players or groups of players established by the players and/or any of the other groups or authorities mentioned herein, e) by an automated method defined by any one or more of the foregoing, and/or f) any combination of these.

According to another embodiment, inter-game trading of attributes may entail the amount of labor required to create an attribute in one environment vs. another. For example, a game attribute coming from a first environment may be converted into a game attribute in a second environment by multiplying the value of the game attribute in the first environment by a conversion multiplier that reflects the difference in the labor (and/or other factors) required to build the game attribute in the first environment vs. the second environment. Alternatively or additionally, the multiplier may take into account any differences in supply, availability, ease or cost of acquisition, or the like, of the resources and/or the prevailing exchange rates of real or virtual currency. Some game environments may be configured to produce items more optimally. These game environments may receive a premium on the exchange in that their labor is more efficient in that game environment than on other game servers. Alternatively, environments that produce such items more optimally, may be penalized or a tariff may be imposed to create a more fair exchange between or among such game environments.

According to yet another embodiment, skills can also be allocated in the same way that resources are selected and placed in a game environment by player characters. Each game environment may have a certain number of skill points that can be attributed to server or player defined trades. In this manner, player characters on one game server can become expert in certain types of trades up to the total skill level specified by the settings of that game environment or server and/or another sever with which they may interact. Skills may optionally be introduced or expanded through education. If certain skills are in high demand, players may choose to pay for an education to obtain these skills. Skills may also be acquired by any one or more of the following including by chance, purchased, learned or passed down from other players, (e.g., from a parent) or acquired through game play, for example, by achieving a certain level or by winning a conflict, war, battle, eating your opponent, casting a spell, etc., and/or by solving a puzzle.

According to another embodiment, non-player characters (NPCs) can be specified, acquired or purchased by player characters. For example, NPCs could serve as drone laborors to collect or develop raw materials and/or to assemble or recycle items in a game environment. Each game server can have a fixed or flexible total number of NPCs, and player characters can determine the max quantity of each NPC that can exist in the game environment. In the case that an NPC is owned or otherwise controlled by a player or groups of players, the owning player or players may be required to pay an additional fee for any resources or skills developed and/or acquired by such NPCs. Alternatively or additionally, rates of acquisition of resources and/or skills by NPCs may affect the rate and/or cost with which other players can acquire such resources and/or skills.

In an embodiment, items may not be built by player characters in a game unless they have purchased a permit to build the item specified. The permit contains a maximum quantity that can be built and what materials can be used to build the item. Every item that is built may need to be registered with a governing body within the game such as a government or other party that controls the territory where the item is being built. Permits can be obtained from the game server or from another player character who has the right to issue permits. A fee can be charged for a permit. According to some embodiments, a bribe can be paid to the player character to issue permits. Each government can post the rates for permits. Based on those rates, player characters can decide their citizenship. Rates for bribes may be set or established by the game, all players, or the government official, who may decide to set the rate based upon the risk associated with taking the bribe, i.e., likelihood of being caught and the cost of the punishment for accepting bribes.

According to some embodiments, items built without a permit are not registered and cannot be sold on exchanges. Alternatively, a black market can exist to buy and sell items that are made without permits.

In an embodiment, a master server may control a finite set of resources for all participating sub servers. This server controls all resources available to other sub servers at a global level, thus permitting games to focus on their versions, plot lines, characters and other unique variables, while the super server controls all the legal and structural matters. In another embodiment, such control may be managed in a peer-to-peer network environment or a combination of server and clients. Enablement of such an environment may be accomplished via the Internet and/or a virtual private and/or a private network.

According to some embodiments, import tariffs can be collected on all or some goods entering a game environment. The player character governments that control a server can set tax rates for each type of resource or item that passes into and out of the server. Such tax rates may be affected, e.g., established, adjusted, etc., based on any tariffs imposed by other servers on exports and/or imports. In this way the system may manually or automatically adjust such tariffs based upon actions taken by other game environments, whether or not such actions are manually or automatically created, modified, raised, lowered or eliminated.

Alternatively, the game server, or one or more player characters could a limit of the number of items that each player can buy or build in a game encironment. As an example, the system could monitor the supply and demand for any given product or product type to ensure that there isn't an oversupply. Oversupply could be defined as any amount that would result in the net real or virtual dollars generated by such an item, i.e., deflation, or on a net basis, i.e., the number items times the then current price. Or, oversupply could be defined as any supply that causes any one of: a game imbalance, an unfair advantage for one person, race, environment, etc., or any other criteria established by the game (either via static or dynamically generated rules/constraints) and/or by any governing body within the game (e.g., a mayor, president, God, congress, etc.). The bodies may be assigned, anointed, appointed or elected, etc.

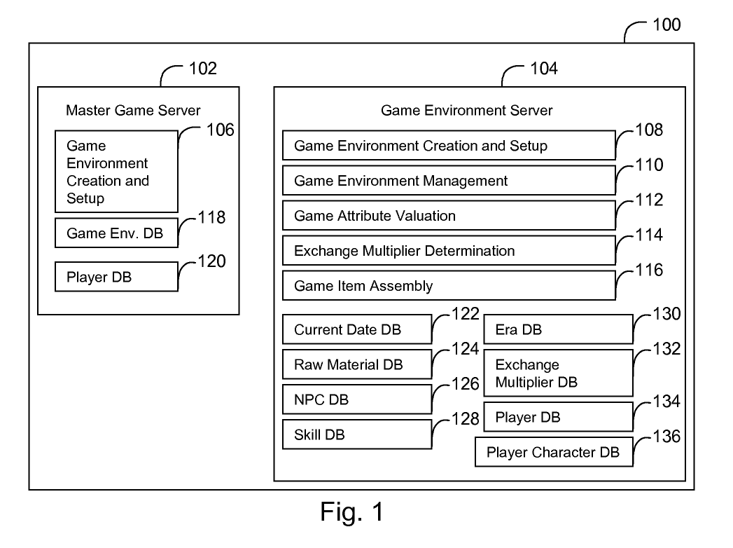

FIG. 1 provides a system 100 suitable for implementation of the game described above. As shown, system 100 includes a master game server 102 and a game environment server 104.

Master game server may host a program such as game environment creation and set up program 106.

Game environment server may host a plurality of programs including, for example:

1. Game Environment Creation and Set Up Program 108

2. Game Environment Management Program 110

3. Game Attribute Valuation Program 112

4. Exchange Multiplier Determination Program 114

5. Game Item Assembly Program 116

Master game server 102 may further host a plurality of database including, for example, game environment database 118 and player database 120.

Game Environment Database 118 may include information such as:

1. Game Environment ID

2. Player Owners 1-n

3. Percentage Ownership 1-n

4. Configuration Settings 1-n

Player Database 120 may include information such as:

5. Player ID

6. Characters 1-n

7. Billing Information

8. Personal Information

Game Environment 104 may include a plurality of databases including, for example, current data database 122, raw material database 124, NPC database 126, skill database 128, era database 130, exchange multiplier database 132, player database 134, and player character database 136.

Current Date database 122 may be configured to. . . .

Raw Material Database 124 may include information such as:

1. Raw Material ID

2. Ray Material Type

3. Location

4. First Date Available

5. Conditions for use

6. Conditions for discovery

7. Conditions for availability

8. Max Quantity Allowed

9. Quantity Issued

10. Quantity Remaining

11. License or Permit Fee

12. Expiration Date

13. Natural Decay Rate/Perishability Factor

14. Available Era(s)

NPC Database 126 may include information such as:

1. NPC ID

2. Type

3. Location

4. Conditions for Use

5. Conditions for availability

6. Max Quantity Allowed

7. Quantity Issued

8. Quantity Remaining

9. License or Permit Fee

10. Available Era(s)

Skill Database 128 may include information such as:

1. Skill ID

2. Type

3. Conditions for Use

4. Conditions for Availability

5. Max Quantity Allowed

6. Quantity Issued

7. Quantity Remaining

8. License or Permit Fee

9. Available Era(s)

Era Database 130 may include information such as:

11. Era ID

2. Date Range

Exchange Multiplier Database 132 may include information such as:

1. Exchange ID

2. Multiplier Number

Player Database 134 may include information such as:

1. Player ID

2. Characters 1-n

3. Billing Information

4. Personal Information

Player Character Database 136 may include information such as:

1. Character ID

2. Player ID

3. Assets 1-n

4. Skills 1-n

5. Obligations 1-n

According to one embodiment, system 100 may be configured to allocate raw material points by performing the following steps:
1. Receive an indication that a game environment has been established
2. Output game environment point configuration options (e.g. to the player(s)
3. Receive a configuration based on options from entity that has established the game environment
4. Store Configuration

According to one embodiment, system 100 may be configured to assemble a game attribute from raw material by performing the following steps:
1. Receive a request to assemble a game attribute, including a blueprint,
2. Create an item record, including a unique serial number, item creator, blueprints used, and other asset information
3. Determine raw materials and skills necessary to complete assembly of item from blueprint
4. Determine existing missing skills and raw materials in the player character account
5. Output existing missing skills and raw materials to player character
6. Receive missing skills and raw materials from one or more player characters
7. Determine a blueprint royalty price for each blueprint needed to assemble item
8. Transfer royalty price from player character account to blueprint owner account
9. Flag item record as complete

According to one embodiment, system 100 may be configured to place raw materials in virtual locations of the game environment by performing the following steps:

1. Receive a Raw Material Allocation Configuration from a Player Character

2. Generate a Game Environment Map

3. Receive a placement of raw materials on the game environment map

4. Store placement of raw materials on game environment map

According to one embodiment, system 100 may be configured to make raw material available based on a game condition by performing the following steps:
1. Determine that a game condition has been satisfied in a game environment
2. Determine if a raw material is to be made available if the condition is satisfied
3. Make raw material available

According to one embodiment, system 100 may be configured to determine an exchange multiplier by performing the following steps:
1. Generate an exchange value for two or more game environment based on activity and conditions in the game environment
2. Create an exchange multiplier based on the relationship of the exchange values between two or more game environments
3. Store exchange multiplier

According to one embodiment, system 100 may be configured to determine the value of item on an exchange based on a multiplier by performing the following steps:
1. Receive a request to purchase an item from a player character in one game environment,
2. Determine available items to fulfill the request that are owned by player characters in other game environments
3. Retrieve the exchange multiplier between the game environments of the purchasing player and the selling players
4. Multiply each available item by the appropriate exchange multiplier
5. Output available items, with a corresponding price that has been adjusted based on exchange multipliers
6. Receive a request to fulfill the request to purchase with one of the available items
7. Withdraw virtual funds from the purchasing player character equal to the purchase price
8. Convert the purchase price using the exchange multiplier into a virtual currency value
9. Deposit virtual currency value into account of selling virtual player

According to one embodiment, system 100 may be configured to allocate skill points by performing the following steps:
1. Receive an indication that a player character has purchased a game environment
2. Generate and Output a configuration request for skill points in the game environment
3. Receive and Store a configuration of skill points

According to one embodiment, system 100 may be configured to allocate NPC points by performing the following steps:
1. Receive an indication that a player character has purchased a game environment
2. Generate and output a configuration request for NPCs in the game environment
3. Receive and Store a configuration of NPCs

According to one embodiment, system 100 may be configured to allocate permit and fee points by performing the following steps:
1. Receive an indication that a player character has purchased a game environment
2. Generate and output a configuration request for permits and fees in the game environment
3. Receive and store a configuration for permits and fees in the game environment

According to one embodiment, system 100 may be configured to sell an item on an exchange by performing the following steps:

1. Receive a request to sell a virtual item on an exchange

2. Determine if item is unique

3. Determine if a permit is required and/or exists to sell the item

4. If the item is unique and a permit is required/exists, post item on exchange

5. Receive acceptance of request

6. Determine an import or other tax amount and an export tax amount

7. Apply import or other tax amount to purchase price

8. Withdraw virtual cash equal to purchase price plus tax from buyer

9. Transmit purchase price, less applicable export tax fees to seller

According to yet another embodiment, the present invention provides an online video game environment where player characters invent items by creating blueprints that are registered to a virtual patent office and used by other player characters. The game environment allows player characters to design and build in-game objects and/or software from artificial, natural or virtual resources and in-game objects that are already in existence in the game environment and/or otherwise transferred and/or permitted by and/or within a game, including, but not limited to in-game objects, virtual blueprints, business processes, software programs, subroutines, etc, which are collectively referred to herein as “objects”.

According to one embodiment, a player character can design an object from a pre-existing game resource(s) and/or items and/or creates human readable and/or machine readable code. The object can be designed and the components required to build the object can be specified. The object can then be registered with a central and/or local virtual patent office. As applicable, each component of the object that was designed by another player character and registered with the patent office receives a royalty. The royalty amount to use the invention design can be specified by the player character registering it with the patent office or via other predetermined or dynamically determined means. The design can specify not only the object, but also the pre-existing tools and resources that are used to create the object.

The patent office may follow rules to determine if an object or other invention, method, or process qualifies for a patent. Such rules may be based in whole or in part on US laws and regulations (which are hereby incorporated by reference in their entirety for all purposes), USPTO rules and regulations (which are hereby incorporated by reference in their entirety for all purposes), US court precedence, and/or any other country's laws, regulations, rules, precedence's, etc., and/or based upon rules and regulations, that may be established by any one or more of: the game manufacturer(s); one or more players of the game(s); representatives appointed elected by the game manufacturer and/or the game players; and/or any other government, body or group of individuals that are duly authorized or are otherwise able to create, impose and/or enforce such laws, rules or regulations.

A system for patent office structure and management has been disclosed by applicants in U.S. provisional patent application No. 60/727,191, which is incorporated herein by reference. Such system may by employed or incorporated in the presently described embodiment.

As a non-limiting example of the present embodiment, a player character can use the raw resource of metal ore, combined with the skills of metal smithing and fire making, to design and build an axe and a saw. The design for the axe and saw, along with the resources, other game items, and attributes required to build them, can be registered with a virtual patent office and sold to other player characters who need them to build, various items. The design may be that of an actual or virtual blueprint, i.e., a drawing with written specifications of manufacture, and/or the design may be a computer program or specification to create a virtual object and its attributes and method(s) of interaction with and/or insertion to a game, game space, or network of one or more games and/or it may be a disclosure of the invention including the necessary information to reduce the item to practice, again, according to rules established by the players, manufacturers, virtual patent office or otherwise.

According to one embodiment, designs can be created using an in game blueprint creator and editor.

According to another embodiment, a first set of items and blueprints can be included with or generated by the game server. Once those items have been assembled, they can be used as building blocks for items created by player characters.

Optionally, items created by player characters can have a limited edition number, GUID or other identifying number, mark, or logo.

Alternatively, the player character could submit the object or document in hard copy or electronic copy, e.g., Microsoft Word file, for subsequent review by the virtual patent office. A player character assembling a new object from existing items may have to purchase or otherwise acquire blueprints for those items along with the raw and/or finished materials needed for those items. Purchasing blueprints can serve the purpose of licensing the intellectual property needed to assemble an item. Once the raw or other materials and blueprints have been purchased or acquired, the player character can then assemble the items either with skills he has or by hiring other player characters with the appropriate skills to assemble the item. If other player characters or NPC's are used to assemble an item, they may be paid a set fee or fees established by the game, free market, player voting, or, in the case of indentured players or NPC's, free (or for a maintenance fee). The assembly of each component that requires the services of an NPC or other player character can be contracted out by posing a request to assemble an item from a blueprint and raw materials. NPCs and player characters can submit offers or accept a posted fee to assemble an item.

According to another embodiment, there can be a marketplace for item blueprints and/or the actual item(s). Each creator of an item can set a price for his item or blueprint. Other player characters can create competing blueprints (if the item or blueprints does not violate a patent right) for items and the marketplace can allow the blueprints to be sold side by side.

The intellectual property system allows player characters to register blueprints for objects. The system also compares the blueprints to existing blueprints to determine if they are patentably distinct. If the system is unable to make such a determination, the matter may be determined by a court of competent jurisdiction (in either the real or virtual world) which may or may not include a judge, arbiter, and/or a jury and/or another governing or administrative body or a group of players or player characters that has been established for the purpose of such review. Each player character must distinguish the blueprint of his item from the prior art. A player character, group of player characters or the game manufacturer and/or game server can act as the patent examiner. A group of player characters who are ranked as experts on a certain class of blueprints can also vote on the patentability of a new blueprint. Player characters can pay a fee in real or virtual dollars to have their blueprint examined and a patent issued on the blueprint. In an embodiment, only blueprints that have been patented can be sold and used in the game environment.

According to one embodiment, certain items cannot be blueprinted unless the player character has access to certain technologies. These technologies can be discovered and/or purchased by the player character, his race, class, or city if they are healthy. Technology discoveries and/or patents can be traded between player characters, cities, races, classes, game servers, and games.

According to one embodiment, a rules based expert system or genetic algorithm can be applied to a blueprint and the prior art to determine the degree of difference between one design and another. If the degree of difference is not of an adequate percentage, the blueprint can be rejected by the patent office system of the game server.

According to another embodiment, every item that is created may have a provenance. All the resource(s), maker(s), item(s), objects, blueprint(s) serial number, edition number, etc that went into creating the object are stored with the object and can be viewed by clicking on a provenance link. Searches can be conducted on items by these provenance categories to locate their positions, prices, availability and owners.

According to one embodiment, the central system can query the database of all items in existence to determine if an item exists that has an identical number to another item. If more than one item exists with the same number, one of them may be identified as a forgery and the item(s) can be flagged as such and/or submitted for further review to the appropriate governing body and/or player characters and/or game servers, etc. Alternatively, a query can be made against an item to determine if the serial number matches the provenance on file, if the item does not match its database entry, it can be flagged as a forgery.

Alternatively or additionally, a player character may assemble a group of game attributes and combine them together in order to generate one-time or ongoing wealth. For example, a player character may need to purchase or inherit a parcel of land, hire a real player or NPC farmer, and purchase seeds in order to grow and sell crops. Groups of game attributes can be combined with other groups in order to generate even greater up front or per turn wealth. For instance a corn farm could be combined with a warehouse to store corn until it can be sold at the highest possible price.

In another embodiment, certain objects, skills, resources, etc., may only be built in cooperation with two or more players, thus requiring certain levels of cooperation to build certain objects and/or obtain certain resources or skills. For example, a game may require that twenty player characters cooperate to obtain certain individual skills, such as physics, electronics, mining, etc in order to build an atomic or other type of weapon. Such requirements may naturally evolve in a game, and/or be pre-established by the game manufacturer, and/or by user groups and/or by majority or other voting systems, etc. The number of game attribute groups that can be created can be limited based on the size of the game environment, city, or player character family and/or by mutual majority or super majority agreement and/or by a vote of the player characters, and/or by a representative governing body.

According to one embodiment, a defined list of grouped attributes and the corresponding game attributes they create on a one time or ongoing basis can be made available to the player characters via a pop up screen.

According to one embodiment, a player character can indicate that he wants to assemble a particular game attribute and the game server can tell him the additional game attributes that are needed to assemble the item. In the case that additional players are required, the game server may be configured to indicate to the player character which other player characters have the skills and/or resources required to complement the requesting player's skills and/or resources.

According to one embodiment, players can pay an additional up front or recurring fee so that their characters can assemble attributes into groups to form new attributes.

According to another embodiment, a player character may be prevented from or otherwise restricted to only being able to build a plan to build an item from resources that already exist in the game and/or that may be transferred into the game from another game and/or exchange. Every item that is created in a game can be registered with a central virtual patent office as an invention. Inventions then become building blocks for new inventions. For instance, a player character can create a door handle. The door handle can be combined with a plank of wood to create a door. The plank of wood could only exist if a saw or other tool was invented to cut the wood.

In an embodiment, the object being designed or created by the player character is in the form of a software application or portion or an application, e.g., a subroutine or software object, that performs one or more functions. For example, the software application may be a program that creates a virtual car wash that, once added to the game space, can provide virtual car washes for virtual cars. The benefits of such software applications can vary widely and owners or licensors of such applications may charge a fee for use of the application and/or usage charges based upon in game play. For example, the game creator may charge player characters 10 virtual dollars to wash their virtual cars. The benefit of such an action may be purely cosmetic or of entertainment value. Alternatively or additionally, such an action may have a beneficial effect on the virtual car, e.g., the car is faster or wears out more slowly.

In another embodiment, all existing issued and pending prior art and patents in the real world become prior art and/or patents in the virtual world and may be recognized as valid intellectual property within the virtual world. Alternatively, only virtual items that are created, developed and/or patented in the virtual world are recognized, meaning that any virtual item may be developed and inventorship is only attributed to the game player.

In an alternate embodiment, a player character can build a plan for an object and assign materials to each piece of the object. The materials that are available may be based on the types of materials that are available in the particular game environment. Moreover, the materials may be limited to only those materials that would be available in the particular era of the game, and the suitable technologies known to the player characters given the game's environment and/or era. Based on the plan and the materials specified, a price may be determined for the materials. A list of NPC and player characters who posses the skills necessary to build the object or pieces of it may also be made available to the player characters. According to some embodiments, player characters can create contracts to build items. Several player characters or NPCs may be needed to create an object, and each character can bid on a part, sub-part or all of the contract. A general contractor may be hired to find, organize, manage, and pay for all necessary resources and/or players or NPCs to build an item.

According to one embodiment, physical limitations can be assigned to game objects. For instance, the weight, size, and shape of an object can be limited based on the player character for whom the item is being made. For instance a helmet has to have a certain diameter, a sword has to have a certain handle size and weight, etc.

According to one embodiment, the size and weight of an item may affect the cost to use an item, e.g., if a vehicle is built, the cost to operate and/or maintain the vehicle may increase with the size and weight of the vehicle. The amount of energy required to use the item, e.g., gasoline for a vehicle, may also increase with the size, weight or shape of the item. Moreover, the ability for an item to perform certain tasks, e.g. for a vehicle to carry a certain load such as passengers and/or items, may be restricted based upon the size and design of the item.

According to one embodiment, the virtual size and weight of an item may affect the effectiveness of the item, e.g., if a sword weighs 50 pounds it may be more lethal when striking a blow, but it may fatigue its user faster than a sword that weights only 10 pounds. Such effects may also be affected by the size and strength of the bearer of arms. For example, a 50 pound sword in the hands of a 300 pound virtual character may be both more lethal and less strenuous than when wielded by a 150 pound player character. In the preceding example, the heavier character may be able to effectively swing or thrust the sword three times per turn, and an unlimited number of times in a given battle sequence, while the lighter player character may only be able to effectively swing or thrust the sword once each turn and only a maximum of five times during the course of a battle sequence.

According to another embodiment, NPC or Player Characters can create any item in a blueprint for a fee. A blueprint can be posted on an exchange and player characters having the appropriate skills can bid to assemble the item. Such bids may or may not include the raw materials necessary to build the item. If raw materials are not included, the player making the request may be expected to supply, purchase or otherwise acquire (e.g., pillage, plunder, or steal) the raw materials and/or the component parts. The player character who posted the item can then accept one of the bids posted on the exchange to assemble the item. Payment terms may be established by the game, players and/or agreed to between the requesting player and the supplier player or NPC. Terms may created using any financial arrangement including but not limited to: cash up front, partial initial payment and lump sum upon completion, credit card or other financing instrument, series of equal or unequal payments, total amount upon completion, etc. Methods to provide for use of credit cards and other financial instruments in virtual environments are disclosed in U.S. patent application Ser. Nos. 11/279,991, 11/380,489, and 11/421025, each of which is hereby incorporated by reference in its entirety for all purposes.

According to one embodiment, other attributes and/or effects may be assigned to an object. For example, use of a virtual lubricant might make a virtual car run faster and/or wear more slowly.

According to one embodiment, a character may only be able to create objects that he has the ability to use. For example, a player character cannot make a blueprint for an item that he does not have the skills to assemble. Characters may hire other players and/or NPCs having the requisite skill(s) to create an item from a blueprint for a fee, or, if indentured, for free.

According to one embodiment, in-game objects can include, but are not limited to:

1. Weapons

2. Tools

3. Buildings

4. Vehicles

5. Workers

6. Devices

7. Designs

8. Programs, e.g., software or “plug-ins”

9. Intellectual Property, including logo's, trademarks, blueprints, etc.

According to one embodiment, players can pay an additional up front or recurring fee so that their characters can build one or more in game objects

When a player character submits a request for an object he has designed to be built, the game server can display a list of the natural resources and quantities required to assemble the object. The game server can also list all the skills necessary to assemble the item and list other player characters or NPCs who have the required skill level to assemble components of the item. The game server may also list any general contractors (within the current or any other connected game) who are available and have demonstrated the skills, connections, etc., necessary to acquire the necessary resources and labor to build the object. Such player and/or contractor listings may be listed alphabetically, or sorted according to any one or more of: experience, other player ratings or rankings, quality, quantity/capacity, price for similar or identical items, bid, availability, reputation, past legal violations, e.g., prior patent infringement or lawsuits or claims by other players, etc. The player character can immediately contact characters who have the necessary skills and/or other desired attributes to build the item and request bids to assemble all or part of the in game object and/or control or manage the process for the player requesting the item(s).

According to one embodiment, the game system can determine the skill level required to assemble an item based on the complexity of the design and the natural resources required to assemble it. For some items the skill level may be greater than the skill that any one or more player character(s) in the game environment has or can have. Moreover, according to some embodiments, a player character with the appropriate skill set(s) may only reside in another game environment. In such a case, in order for the item to be assembled, the player character may be required to sell his blueprint(s) on an intra or inter game environment exchange to the character with the appropriate skill set(s), have the item built by the player character with the appropriate skill set(s), and then purchase the item on the exchange from the charcter with the appropriate skill set(s).

According to one embodiment, a table, rules-based system, or genetic or other algorithm may be used to determine the skill level required to assemble an item and assign that skill level to a blue print.

According to one embodiment, certain skill levels and types may only be available in certain game environments. These skills may trade on intergame servers.

According to one embodiment, exchanges can exist between cities, states, races, clans, classes or other collections of players in a game environment and/or multiple connected game environments.

According to one embodiment, items can be invented and registered with a patent office server that manages the filing of blueprints from all game environment servers. According to some embodiments, if a blueprint is created and filed in one game environment, it cannot be created and filed again in another game environment.

According to one embodiment, a virtual or real cash fee can be charged to a player character who wants to register a blueprint to be patented. A portion of this fee can be paid to other player characters who are willing to examine the filed blueprint for patentability. In one embodiment, such volunteers or paid examiners must agree that they cannot create or be involved with the creation of patents in the field of use for applications that they agree to examine. In another embodiment, examiners are hired and governed by laws and rules, such as the laws and rules of the United States of America, the USPTO, or by laws, rules and regulations established by the game manufacturer, one or more players in the game designated for such purpose, any other body elected by the players and/or appointed by the game manufacturer, and/or any other entity that is duly authorized to appoint and/or hire examiners.

According to one embodiment, the licensing fee a player can charge for a patent blueprint can be a percentage of the total item value on an exchange at the time the item is created. The percentage can be variable. For example, a patent with a higher licensing percent fee can have a shorter life than a patent with a lower percent licensing fee. For example, a player can receive a 10% license fee for a patent blueprint for one year or 10,000 units, or could receive a 5% license fee for a patent blueprint for three years or 30,000 units. Alternatively, the fixed or flat fee of a patent license can have an effect on the life of the patent. For instance, a player can elect to receive $10 virtual dollars for the use of a patent blueprint for one year or 10,000 units, or can receive $5 for three years or 30,000 units.

According to one embodiment, the total resources, virtual assets, or skills need to create an item from a blueprint can have an effect on the maximum licensing fee that a player can charge to use a blueprint to create an item. For example, a virtual shovel can have a maximum blueprint license fee of $1, but a virtual space station can have a maximum blueprint license fee of $2000.

According to one embodiment, the blueprint licensing fee can be reduced over time or when a certain number of units of an item have been created. For instance, a license to assemble an item from a blueprint can be $10 for the first year or 10,000 items, and $5 for the second year or second 20,000 items.

According to one embodiment, patent blueprint ownership can be transferred from one assignee to another on an exchange.

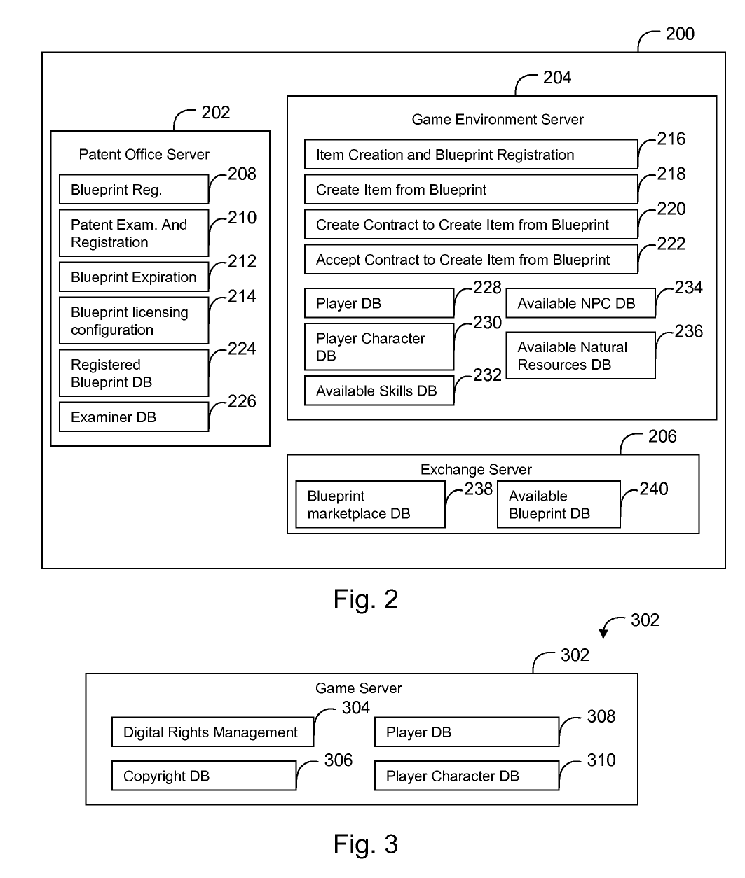

FIG. 2 provides an exemplary system 200 that may be used to provide the embodiment described above. As shown, system 200 may include a patent office server 202, a game environment server 204, and an exchange server 206.

Patent Office Server 202 may include or host various programs, routines, or subroutines including, but not limited to:

1. Blueprint registration program 208

2. Patent examination and issuance program 210

3. Blueprint patent expiration program 212

4. Blueprint licensing configuration program 214

Game Environment Server 204 may include or host various programs, routines, or subroutines including, but not limited to:

1. Item creation and blueprint registration program 216

2. Create item from blueprint program 218

3. Create contract to create item from blueprint program 220

4. Accept contract to create item from blueprint program 222

Moreover, patent office server may host one or more databases including, as non-limiting examples, a registered blueprint database 224 and an examiner database 226.

Registered Blueprint Database 224 may include information such as, but not limited to:

1. Blueprint ID

2. Blueprint Inventor

3. Blueprint Assignee

4. Blueprint Class

5. Blueprint Subclass

6. Blueprint Status

7. Blueprint Content

8. Skills Required to assemble item from blueprint

9. Blueprints required to assemble blueprint

10. Resources required to assemble blueprint

11. Blueprint Registration Date

12. Blueprint Royalty/Licensing Configuration

13. Examiner ID

14. Max quantity

15. Quantity remaining

16. Quantity sold

17. Expiration Date

18. Expiration Quantity

Examiner Database 224 may include information such as, but not limited to:

1. Examiner ID

2. Examiner Class

3. Examiner Subclass

4. Examination History

Game Environment Server 204 may include one or more databases such as, without limitation, player database 228, player character database 230, available skills database 232, available NPC database 234, and available natural resource database 236.

Player Database 228 may include information such as, but not limited to:

1. Player ID

2. Player Characters 1-n

3. Player Personal Information

4. Player Billing Information

Player Character Database 230 may include information such as, but not limited to:

1. Character ID

2. Player ID

3. Character Assets

4. Blueprints Invented

5. Blueprints Owned

6. Skills 1-n

7. Skill level 1-n

Available Skills Database 232 may include information such as, but not limited to:

1. Skill ID

2. Skill Descriptor

3. Maximum Allowed (per level)

4. Issued to date (per level)

5. Remaining to be issued (per level)

6. Permit Price

7. Available Date Range

8. Last market value levels 1-n

9. Max level

Available NPC Database 234 may include information such as, but not limited to:

1. NPC ID

2. NPC descriptor and attributes

3. Last Market Value

4. Maximum Allowed

5. Issued to Date

6. Remaining to be Issued

7. Issuance conditions

8. Dates available

9. Permit Price

Available Natural Resources Database 236 may include information such as, but not limited to:

1. Resource ID

2. Resource Descriptor

3. Last market value

4. Maximum Allowed

5. Issued to Date

6. Remaining to be issued

7. Permit Price

8. Available Date Range

9. Last market value

10. Resource Attributes 1-n

Exchange Server 206 may include various database including, but not limited to, blueprint marketplace (or exchange) database 238, and available blueprints database 240.

Blueprint Marketplace (or Exchange) Database 238 may include information such as, but not limited to:

1. Game Environment ID

2. Transaction Fee

3. Monthly Fee

Available Blueprints database 240 may include information such as, but not limited to:

1. Blueprint Number

2. Blueprint Price (by usage type)

3. Quantity Remaining

System 200 may be configured to determine if a blueprint can be patented by performing steps such as:
1. Receive a blueprint filing, including a player character inventor ID, a virtual entity assignee ID, a blueprint design, a blueprint class and subclass, required resources and skills to assemble the blueprint, and required other blueprints to assemble the blueprint
2. Compare filed blueprint to existing filed blueprints and generate a similarity rating
3. If similarity rating is greater than allowable threshold, flag blueprint as requiring further examination.
4. If similarity rating is less than allowable threshold
5. Generate a patent number
6. Assign patent number to blueprint record
7. Notify blueprint owner that blueprint has been patented
8. Post blueprint in patent office

System 200 may be configured to pay examiners for reviewing blueprints by performing steps such as:
1. Output a blueprint that has a similarity rating higher than allowable threshold to a player character
2. Receive opinion from player character that blueprint can be patented
3. Generate a patent number
4. Assign patent number to blueprint record
5. Notify blueprint owner that blueprint has been patented
6. Post blueprint in patent office
7. Set Up Blueprint Licensing Structure
8. Receive a request to set up a blueprint licensing structure
9. Output allowable licensing structure, including per usage fee, usage type, maximum usage (limited edition number)
10. Receive a licensing structure configuration
11. Store licensing structure configuration with blueprint

System 200 may be configured to create an item from a blueprint by performing steps such as:
1. Receive a request to create an item from a blueprint from a player character
2. Generate and Output a licensing amount to the player character
3. Receive an acceptance of the licensing amount from the player character
4. Generate a blueprint license number
5. Create a new item record, including blueprint license number
6. Generate and Output a list of necessary virtual skills, resources, blueprints, and components necessary to assemble item
7. Receive necessary skills, resources, blueprints, and components necessary to assemble item
8. Create item
9. Output item to item creator
10. Output licensing payment, less applicable fees to patent assignee

System 200 may be configured to post a contract to build an item from a blueprint by performing steps such as:
1. Create a contract to build an item, including the item record, the date of completion, the necessary skills, the actual virtual assets need to assemble the item, and a contract price from a player character
2. Store contract offer
3. Withdraw contract offer price, plus applicable fees, from player character account

System 200 may be configured to accept a contract to build an item by performing steps such as:
1. Receive an acceptance of a contract offer to assemble an item from a blueprint
2. Receive an indication that a contract has been completed
3. Flag item record as complete
4. Transmit payment for fulfilling contract, less applicable fees, to player character

System 200 may be configured to make a bid to build an item by performing steps such as:
1. Receive a counter offer to a contract offer to assemble an item from a blueprint, including a counter offer price and assembly date from a player character
2. Store and output offer to the player character who initially created the contract offer

System 200 may be configured to post a blueprint patent on an exchange in order to transfer an assignee by performing steps such as:
1. Receive an offer to sell a blueprint patent, including an offer price, a remaining edition number from a player character who controls a blueprint assignee.
2. Store offer and post offer on exchange

System 200 may be configured to purchase a blueprint patent on ab exchange by performing steps such as:
1. Receive a request to purchase a blueprint patent from a player character
2. Receive a new assignee name
3. Withdraw purchase price, including applicable fees, from new assignee account
4. Transfer blueprint to new assignee
5. Transmit purchase price, less applicable fees, to former assignee of blueprint patent

System 200 may be configured to expire a patent or copyright term by performing steps such as:

1. Determine that a blueprint patent has reached its expiration date

2. flag licensing configuration for patent blueprint as expired

System 200 may be configured to find duplicate items or forged items by performing steps such as:

1. Retrieve an ID number for a virtual asset that is posted on an exchange

2. Determine if ID number is a valid number

3. Determine if ID number is unique

4. Remove item from exchange if ID number in not valid or unique

According to yet another embodiment, the present invention provides a system and methods for digital rights management in a video game environment. According to one embodiment, a player character can acquire, buy, and/or create music, text and images (or the real or virtual rights to these or other copyrightable materials) that other player characters can subscribe to and use in their virtual spaces. For example, a player character creates images, text and music either by using editors in the game environment or by importing them from a remote editor. Each image, text and or song is registered with the copyright office of the game or an independent copyright gaming system. The copyright office system determines if the image, text or song is distinct from text, songs and images already copyrighted. If the system determines that the text, song or image is unique, a copyright can be obtained.

According to one embodiment, images, text and songs can then be sold on an exchange. Other player characters can buy the right to use the images, text and songs in virtual structures they have created. Pricing for the images, text and songs is based on the virtual space in which they are being used. For example, the use of a set of one or more images and or one or more songs in a virtual house costs $x virtual or real dollars per virtual or real time period, while showing the same image(s) or playing the same song(s) in a virtual restaurant may cost $y virtual or real dollars. Fees to use images, text and songs could be set on the number of unique impressions of those images by player characters or for an unlimited use license. The system can track how many player characters were exposed to or otherwise used, viewed or played the image or song and charge the owner of the billboard or virtual space where the image or song is being used a per use fee.

According to one embodiment, the methods, laws, rules and regulations for the virtual copyright office to follow to determine if an image, song, text or other work is the valid property of an applicant may be determined solely or in part by the laws, rules, regulations and precedence of the United States of America and/or the USPTO (each of which is hereby incorporated by reference in its entirety for all purposes) and/or by one or more laws, rules regulations and precedence of one or more foreign countries, and/or by laws, rules and regulations created or passed by any one or more of the a) game manufacturer, b) one or more player characters assigned that duty and who otherwise posses the right and obligation to perform such duties, c) a representative government elected by a majority or super majority or other voting methods as established by the player characters, user group, manufacturers, group or consortium of manufacturers and/or player characters, and/or any combination of these.

FIG. 3 provides an exemplary system 300 that is suitable for use with the embodiment described above. As shown, system 300 includes a games server 302 which may include or host various programs, routines, or subroutines including, but not limited to a digital rights management program 304. Game server 302 may further maintain or be in contact with a plurality of databases, examples of which include, but are not limited to a copyright database 306, a player database 308, and a player character database 3 10.

Copyright Database 306 may include information such as, but not limited to:

1. Copyright ID

2. Copyright Owner

3. Copyright Creator

4. Royalty/Licensing Configuration

5. Copyright content

Player Database 308 may include information such as, but not limited to:

1. Player ID

2. Player Billing Info

3. Player Personal Info

4. Player Characters 1-n

Player Character Database 310 may include information such as, but not limited to:

1. Character ID

2. Player ID

3. Character assets 1-n

4. Character attributes 1-n

5. Character copyrights invented 1-n

6. Character copyrights owned 1-n

System 200 may be configured to determine if an item can be copyrighted by performing steps such as:
1. Receive a request to copyright an item from a player character, including the item
2. Determine if item can be copyrighted based on other copyrighted items
3. If item can be copyrighted, copyright item and output copyright notice to player character

System 200 may be configured to establish copyright royalty payment criteria by performing steps such as:

1. Output Royalty Payment Criteria Options

2. Receive Royalty configuration based on options

3. Store royalty configuration

System 200 may be configured to sell rights for the usage of copyrighted items on an exchange by performing steps such as:
1. Receive a request to use a copyrighted item, including a usage type from a player character
2. Determine royalty payment based on royalty configuration
3. Charge royalty payment to player character
4. Issue item to player character
5. Transmit royalty payment, less applicable fees, to copyright holder.

System 200 further may be configured to charge a royalty fee when an item is used in a game environment by performing steps such as:
1. Receive an indication that a copyrighted item has been used by a player character in a game environment under a particular usage type
2. Determine a royalty payment based on usage type
3. Charge royalty payment to player character
4. Transmit royalty payment, less applicable fees, to copyright holder.

Accordingly, a virtual embodiment may be configured to allow player characters to create digital works that are accessible in the virtual environment and ensure that an author of a digital work receives compensation from other player characters that access the digital work. It will be appreciated that for the purposes of the present disclosure the term “author” is intended to mean any entity that creates a digital work including, but not limited to, the author of a literary work, a composer, an artist, a choreographer, a lyricist, a computer programmer, a lexicographer, a photographer, a producer, or any other entity or entities that create a digital work.

In order to accomplish the above-mentioned goals, the virtual environment may include a digital work editor and a virtual copyright office. The digital work editor may provide the author with tools needed to create the digital work. Accordingly, the digital work editor may provide access to musical instruments, paint, canvases, bronze, clay, publishing tools, cameras, etc.

The virtual copyright office may be configured to receive copyright applications and determine if the digital work associated with the copyright application is unique to the virtual environment. For example, the virtual copyright office may be configured to compare the digital work with other digital works that have been previously submitted to the copyright office. For the purposes of the present disclosure, the term “copyright office” is intended to mean any entity that has authority to bestow copyright ownership upon an author. For the purposes of the present disclosure, a “copyright” is the right to prevent others from using the digital work. For the purposes of the present disclosure “use” includes, but is not limited to, copying, distributing, viewing or listening to the digital work.

According to some embodiments, a virtual character may want to use a digital work that exits in the virtual environment. For example, virtual character A may wish to hang a painting created by virtual character B in the living room of A's virtual house. Accordingly, once a request to use a digital work is received, the game server may be configured to identify whether the digital work is subject to copyright. If it is, the server may further be configured to determine who the copyright owner is. It should be noted that the copyright owner need not necessarily be the author of the work, since, an author may be allowed to sell or otherwise transfer copyright ownership to another entity. Upon a determination that the work is subject to copyright, the copyright owner may be given the right to refuse the use request. Alternatively, the copyright owner may suggest or be automatically paid a royalty, license fee, or other compensation.

According to yet another embodiment, the invention provides methods and systems for providing inter and intra game exchanges between massive multi online player video games. According to one embodiment, a method and system are disclosed for providing markets for virtual game attributes between (i) player characters in a game server (ii) cities or groups of player characters in a game or multiple game environments (iii) game servers of a massive multi online player video game and (iv) multiple different massive multi online video games.

According to one embodiment, player characters can purchase exchange seats on a game server that allow the player characters to create markets for certain game attributes. Exchange seats can be purchased with real or virtual cash, or can be earned when the player character performs certain actions such as when the player character, reaches a certain level in the game, acquires a certain game attribute, or plays a certain amount of time in the game environment. According to one embodiment, exchange seats can be lost if other player characters complain or vote to remove the player character who controls the seat from his position.

According to one embodiment, virtual video game exchanges function similarly to real world exchanges. The laws, rules, regulations and precedence of the exchange(s) may be based, solely or in part upon any one or more or a combination of, the laws, rules, regulations and precedence of the United States of America and/or any foreign country, and/or those of the NYSE, NASDAQ or the American stock exchange, and/or those established by the game manufacturer, and/or by one or more player characters who have been duly appointed and/or anointed, and/or elected by the player characters via a majority or super majority vote or other voting method, and/or any player character or governing body duly authorized to create, pass, modify, overturn or enforce such rules, laws, regulations, etc. The laws of the United States of America and its case law and the rules and regulations of the NYSE, and NASDAQ, and the American Stock Exchange are all hereby incorporated by reference in their entirety for all purposes.

Player Character can post buy or sell orders for attributes that are listed on the exchange. The following orders are non-limiting examples of orders that player characters can place in an in or intra game exchange:

Marketplace-a marketplace allows buy and sell (and/or put and call) orders for resources and attributes to be placed by player characters who have an account with a player character who has a seat on the exchange. The player character who owns the exchange seat fills or matches the orders.

Auction-an auction allows player characters who have an account with a player character who has a seat on the auction to post items for sale and to bid on items posted. The highest bid for an item within a certain time period wins the item for the bid amount.

Dutch Auction—a Dutch auction allows player characters who have an account with a player character who owns a seat on the Dutch auction to post items for sale with several prices that descend over periods of time. Player characters can purchase these items at the posted price, or wait until the next price period to purchase them at the subsequently lowered price.

Market Order—player characters can place an order to buy an amount of a game attribute. The attribute is purchased or sold at the market price either in the full amount or in parts of the full amount until the full amount has been reached

Stop Loss Order—an order can be placed to sell a game attribute if the market price reaches a certain limit. When the market price reaches that limit, the game attribute is sold.

Limit Order—an order can be placed to buy or sell a game attribute for a fixed price. The order can have an expiration date.

Fill or Kill order—an order can be placed that requires a fixed amount of a game attribute to be bought or sold within a given time period. If the exchange cannot fill 100% of the order, the order can expire without being partially filled. The order may have a set price, price range or accept a “market price” setting.

Short Selling—A player character can sell a game attribute he does not own. The second player character purchasing these phantom game attributes can request possession of the game attributes. If the first player character is unable to provide the game attributes he has sold short, he can be charged the market value and or a fee to fulfill his obligation to the first player character.

Alternatively or additionally, rather than placing an order to buy an actual game attribute, player characters can, for example, buy futures or options to buy the game attribute for a set price at a future date.

For example, a player character can place an order to buy 1000 virtual thistle bush seeds on Jun. 20, 2006 for $1 virtual dollar per seed. The contract could cost 0.10 cents per seed or $10. The player order could be filled for a price of $10 by another player character who is obligated to deliver 1000 virtual thistle bush seeds for $1 virtual dollar per seed on Jun. 20, 2006. Conversely, a player character can place an order to sell 1000 virtual thistle bush seeds on June 20^{th} for $1 virtual dollar per seed. This player character could be a virtual thistle bush farmer who wants to lock in the price of his virtual game attribute before his crop is ready.

In an embodiment, exchanges are the only place in the game environment where an item can be guaranteed to be delivered if it is purchased. If a seller of a game attribute cannot fill his order, the owner of the exchange seat must do so in his stead. Such guarantees may be backed by an insurance policy and/or another financial instrument such as a virtual or real credit card.

According to one embodiment, player characters can purchase a seat on an exchange that gives them the right to buy and sell the game attributes allowed in that particular exchange. Initially, a player character can purchase or earn a seat on an exchange from the game server. Once the seat is owned by a player character, it can be sold to other player characters, provided those player characters are allowed to own seats on exchanges.

According to one embodiment, player characters can make real or virtual money if they own an exchange seat by performing any one or more of the following actions:
1. Charging a monthly fee to each player character who has an account on the exchange
2. Charging a per transaction fee to each player character who sells a game attribute on the exchange
3. Creating a spread between the buy and sell (and/or bid and ask) price of a game attribute.
4. Charging a percentage fee based on the total transaction amount.

According to one embodiment, a player character can manage his seat on an exchange by (i) making buy and sell decisions on each order that is placed by another player character (ii) by setting up buy and sell parameters for game attributes (iii) by hiring an NPC or a contractor or financial services consultant (i.e., another player character that provides such services) to manage his seat on the exchange.

According to one embodiment, a player character who owns a seat on an exchange can offer exchange accounts to other player characters for a monthly or per transaction or other fee. When a player character elects to use his exchange account to sell a game attribute, he may be required to pay a transaction fee to the exchange owner.

According to one embodiment, a player character who owns a seat on an exchange can set up order rules. Examples of rules that may be set up include, but are not limited to:
1. Player characters need a credit score of x or above to have a margin account on the exchange
2. Certain orders are allowed on the exchange while others are not.
3. Limits can be placed on the amounts of a particular game attribute that can be exchanged in a given time period.
4. Exchanges may only be available during certain time periods
5. What player characters are able to place orders on an exchange can be limited by game, server, territory, government, race, class, skill, level, etc.
6. What items can be exchanged

According to one embodiment, player characters may also set up alerts to notify them prior to or upon any exchange being consummated. Alerts may also be established to monitor the number, type, price, trends, etc. for any one or more game attributes. Alerts may be sent via messages within the game space and/or into the “real world” using e-mail, or text or voice messaging.

According to one embodiment, based on the rules set up by the player character with an exchange seat, an insurance premium can be determined by the game server or a player character who provides insurance.

According to one embodiment, a player can place market orders up to the value of the cash in his virtual account he has established with an exchange. Alternatively, the exchange can issue credit to a player character that allows the player character to place market orders in excess of the value of the virtual money he has in his exchange account. Such margin account may be “guaranteed” by a virtual and/or real credit card or other financial instruments, including real stocks and/or bonds and/or lines of credit.

According to one embodiment, the dates that orders are specified can be in game “virtual” time or in real world time.

According to one embodiment, exchanges may be open 24 hours a day, seven days a week, or may conform to any other schedule such as those followed by real world markets and/or as the game manufacturer or player characters or the exchanges themselves may establish from time to time. The game may require the game character to confirm a buy or sell order before consummation of the transaction, even if the transaction is automated. Such confirmation may be made while playing the game and/or via notices sent to and received from any one or more of an e-mail account (within the game and/or in the real world), voice mail or text messages.

According to one embodiment, when a player character places a sell order on a game attribute, the game attribute can be placed in escrow or it can remain in the possession of the player character until it has been sold on the exchange. If a player character is not able to deliver an item that he has sold on an exchange, the market value of that item and or a fee can be charged to the player character account.

According to one embodiment, if a player character fails to deliver a game attribute listed for sale and/or fails to pay for a purchased game attribute, that player character may be precluded from further transactions for a period of time or indefinitely and/or until he delivers the attribute and/or makes payment in full. Moreover, the user may have to pay a premium for any subsequent transactions or for a certain period of time.

According to one embodiment, players can pay an extra up front or monthly fee so that their player characters can (i) have the right to own a seat on exchange (ii) have the right to have an exchange account and or (iii) have the right to sell a game attribute to an exchange.

According to one embodiment, a player character who owns a seat on an exchange can purchase insurance from other player characters, a separate but connected server that provides this service, and/or the game server to cover trades when player characters who place orders on the exchange cannot fill the order. Insurance can be purchased for a certain virtual or real dollar amount that is commensurate with or otherwise based upon the credit risk taken by the insurance provider. Risk can be determined by (i) the credit scores of all player characters who have an account with the exchange (ii) the total margin dollars in use by the player characters who have an account with the exchange, or (iii) a combination of the rate of failed or fraudulent transactions for all transactions or a subgroup or specific type of transactions for recent or long term transactions and/or any other variables.

For example, a player character short sells 2000 virtual pine timber planks for $3 virtual dollars per plank. The price of virtual pine skyrockets to $10 per plank, and the short seller cannot cover the $14000 virtual cash loss plus the fees. The player character who owns the exchange seat has to guaranty the transaction, so is obligated to pay the $14000 in virtual cash when the short seller defaults. The player character who owns the exchange can file a claim on his exchange insurance to cover the loss.

According to one embodiment, other player characters can vote to force a player character who owns an exchange seat to sell it. For instance a player character who owns an exchange seat is driving up the price of a game attribute by limiting supply. Other player characters can vote with the central server or player character government to force the player character to sell his seat on the exchange. The exchange seat is put on the market and sold to the highest bidder.

According to one embodiment, an exchange can be run as an auction. The player character running the auction can either act as the auctioneer or hire an NPC to be the auctioneer.

According to one embodiment, a Dutch auction exchange allows a player character to post a game attribute or group of game attributes for sale at a range of prices. The attribute(s) are placed for sale at the highest price in the range and the price is periodically lowered to the bottom end of the range until the attribute(s) have sold.

According to one embodiment, exchanges may only be able to trade certain attributes during certain periods of a game (e.g. certain eras, certain times of days, days of a week, or any combination of these, etc.). For instance, a given game may specify that iron can be trades in eras 3-4 of a game environment, but not eras 1-2. However, the game may also specify that futures for these items may be purchased at any time. In this manner, as game servers move through eras (or other time periods), futures traders can anticipate and exploit the use of raw materials between game servers.

According to one embodiment, exchanges may only be available in certain cities or other areas of a game environment that have discovered and or implemented a certain technology in the game.

According to one embodiment, exchange seats and accounts may only be available to player characters of a certain level, race, class, and or who have acquired certain skills.

According to one embodiment, certain governments may allow only certain types of markets, i.e. orcs can only have Dutch auctions but not exchanges.

According to one embodiment, certain game attributes may only be sold in certain types of marketplace(s).

According to one embodiment, exchanges can be placed in a game environment, between game servers, between games, or in some other suitable location. Player characters can use an exchange placed in a game environment to buy and sell items within a game environment. Player characters can use an exchange placed between game servers to buy and sell items between two servers of the same game i.e. World of Warcraft Server 1 and 2. Player characters can use an exchange placed between games to buy and sell items between two entirely different games, i.e. World of Warcraft and Second Life.

According to one embodiment, attributes exchanged may need to be verified as authentic. Each game server may create and attach a digital signature to one or more game attribute(s). When an item is exchanged, its digital signature may be verified before the transaction is completed. If the item does not have an adequate digital signature, then it is returned to its owner and a penalty is charge. Each item may also have a unique inventory number.

According to one embodiment, the owner of an item is stored with its inventory number and transferred when the item is exchanged. If an item that is being exchanged has an inventory number and owner number that do not match to a central database, then the item is returned to its owner or destroyed and a fee is charged to the owner.

According to one embodiment, the per transaction or monthly fee that a seat exchange owner can charge to a player character with an exchange account can be based on that player character's credit score.

According to one embodiment, an attribute may have more than one inventory item number to permit conversion of an attribute from one game to another. The item may also have a real or virtual bar code and/or an ID tag number.

According to one embodiment, the exchanges available on a given game server or game environment can be limited based on the resources available on that game server.

According to one embodiment, an attribute may have a static or variable conversion rate or factor to provide a means to convert game attributes from one game to another, or from one era to another or from one area within a game to another. For example, a gallon of oil may translate into two gallons of oil when traded from War Craft to Second Life.

Moreover, other conversions may be permitted, for example, a barrel of oil may be converted into 10000 thistle seeds within a game environment, and/or a barrel of oil may be converted to 5000 thistle seeds when exchanged between two games such as War Craft and Second Life. Multiple item exchanges may also be supported, e.g., a barrel of oil and 10,000 thistle seeds may be exchanged for 100 axes.

Static conversion tables or rates may be maintained by the system, or an automated trading system, one or more player characters, and/or NPC's, or by an exchange, or via the open market, or any combination of these alternatives.

According to one embodiment, the game server can set a maximum trade amount per time period on currency and other resources both in the game environment and between game environments. This amount could be based on any one or more of:
1. The total amount of a resource available in a game parameter
2. The amount per player character of a resource available in a game parameter
3. The amount of open buy orders for a resource in a game environment
4. The amount of open sell orders for a resource in a game environment
5. Any other factors and/or rules and regulations as disclosed herein above.

According to one embodiment, each game environment could have multiple types of currency that can be traded on an exchange within the game environment. For example, Orcs could have Orc Dollars and Humans could have Human Dollars.

Furthernore, each game environment can have multiple currencies that can be exchanged with other game environments through either intra or inter-game server currency trades. For instance, gold on one server of World of Warcraft may be worth more than gold on another server because one server is more developed or more desirable to play on and/or the gold in one game may be more fully backed by real currency and/or other real financial instruments, making such virtual currency or attributes more or less secure/risky.

Moreover multiple currencies can be exchanged between two distinct games. For example, the gold and silver of World of Warcraft can be traded with Linden Dollars and Linden Yen.

Alternatively or additionally, each game environment can have a unique set of currencies that can be exchanged with a set of currencies that is a global set of currencies for multiple game environments. For example. World of Warcraft Server 1 gold and World of Warcraft Server 2 gold can be exchanged for World of Warcraft Gold, which can then be exchanged with Linden Dollars.

As a further embodiment, virtual currency, game attributes, etc., may be traded on real exchanges within the real world.

According to one embodiment, seats on exchanges can be made available in game environments when those game environments reach certain qualification criteria such as a number of players, a certain virtual asset value, a certain age, etc.

According to one embodiment, in order for a game to be listed on an exchange, it may be required to comply with a universal size system so that the objects created in the game can be used in other games. Alternatively, a conversion table or rate may be employed to provide exchange among games or to provide a bartering system within a game, e.g., trading oil for thistle seed.

According to one embodiment, certain natural resources may only be made available within certain game parameters. For instance, wood may only be grown within some game environments and then traded on exchanges to be imported into other game environments.

According to one embodiment, exchange seats may be bought and sold on exchanges. Moreover, player characters who own exchange seats may be forced to sell their seats via a majority vote or by another appointed or anointed governing body if they are not being fair. Rules to prevent collusion between exchange seat owners can also be set up and enforced by the game server or by other player characters who can regulate the exchanges. Player character governments can specify the rules for exchanges that exchange seat owners have to abide with in order to keep their exchange seat. A player characters can be forced by the game server or by an in game government run by other player characters to sell their exchange seat if they break the rules of the exchange. According to one embodiment, the player character or the game server can determine the value of options and futures for game items based on the quantity available and being traded.

If a game environment is managed by a government, that government can levy a tax on all items that are imported into or exported out of the game server via exchanges

Examples of virtual assets that can be traded on Exchanges include, but are not limited to:
1. Options, puts, calls, etc.
2. Player Characters or avatars
3. In Game Resources or attributes
4. Player Created Game Items
5. Stock of a game businesses
6. In game currency
7. Bonds of in game businesses
8. Bonds of in game cities
9. Blueprints and Patents of game items
10. Stock in game environments
11. Virtual and or Currency
12. Game Attributes created by Player Characters
13. Game Attributes created by the Game Server or NPCs
14. Natural resources
15. Player Characters
16. Exchange Seats
17. Stock in virtual game companies
18. Contracts that one Player Character has with another Player Character
19. Labor of certain skill types and levels
20. Resources, raw or finished goods or services
21. Blueprint licenses (exclusive or non exclusive)
22. Blueprint assignments
23. Songs
24. Videos
25. Images
26. Products
27. Software applications and/or libraries, languages, SDKs, tools, objects or portions thereof.
28. Interface specifications
29. Any other objects permitted or are otherwise in existence within a game.

In an another embodiment, a central system can act as an exchange between several game environments. At first, a limited number of game environments may be available to player characters for purchase. One or more player characters can buy a game environment, and configure the rules for other player characters to play in the game environment. The value created in the game environment by player characters can be sold on the central exchange. Player characters coming into the game can select a game environment where they want to play based on statistics about the laws and size of all or some of the game environments. Player characters who perform well in other player character game environments can earn the right to buy a new game environment or character within a new game environment when it is released by the central server.

According to one embodiment, there may be a number of game environment points that can be spent on natural resources. Player characters that own the game environment can select the natural resources that are available in their game (this could be, for example, a per turn replenishing amount, a fixed amount of each type by era, or just a fixed amount at the beginning of the game environment that is used up or traded over time). A piece of all trading done by player characters in the game environment can be given to the central system in the form of money or a percent of goods, etc. The money collected by the game parameter controllers can be used to purchase items from other game parameters to make their game parameter more desirable (building designs, weapons in missions, etc.)

According to one embodiment, the system may provide for inter-game and Intra-game stock exchange of companies.

According to one embodiment, player characters or other game attributes can be sold between game servers of the same game and/or among those games that provide for conversion rates or exchanges for characters or any game attributes between one or more heterogeneous games. Such sales may be managed, for example, by an intra-server player character auction.

According to one embodiment, Dutch Auctions may allow player characters to post an item or resource, or group of items or resources and set a range of prices at which the items can be sold. A first price is set with a first time limit. A second price is set with a second time limit, and so on. When the first time limit is reached, the price is dropped to the second price and so on, until the item or group of items has sold. The price could be for some of the total amount of items, or may be for all items. i.e. a player character can specify that all items must be sold in one transaction, or the items can be sold in multiple transactions.

According to one embodiment, goods sold could come with a warranty. If an item wears out, it can be replaced using the warranty.

Alternatively or additionally, users may exchange real world goods and services for virtual goods and services. An exchange could be created that specifies real world goods available along with a list of virtual goods that the player character is willing to exchange them for. For example, a player character could post an actual computer that they would like to trade for 100 wood planks in a game environment.

According to one embodiment, every player character in a game environment may have created a certain amount of virtual wealth in that game environment that is measurable. The sum of all that virtual wealth (less debt if any) can be considered the virtual value of the game environment. This virtual value can be listed on an intra or inter-game exchange. The virtual wealth of a player character in the game environment can be exchanged for shares of the game environment. Thus, game environments with healthier economies can trade for more value than game environments with weaker economies. Alternatively, a game environment can “go public” i.e., make an initial public offering, by issuing and offering shares on an exchange. Every player character with positive net wealth or with appropriate credit (real or virtual) on the exchange can receive shares in the game environment equal to the amount of wealth and/or credit he has. The in game wealth and the game environment stock can be traded on separate exchanges.

According to one embodiment, IPO's of game environments can occur when the stock exchange has been discovered in the game environment, when the game environment reaches a certain age in real or virtual time, when the game environment reaches a certain level of wealth, when the game environment reaches a certain player character population, when the game environment discovers a certain technology, or any other trigger or event that permits the existence of a stock exchange, including, but not limited to, a vote or other permitted action taken by one or more player characters. Player Characters in the game environment may race or compete to create wealth in the game environment so that the game environment reaches the IPO trigger or threshold more quickly and/or with the highest possible valuation.

Alternatively, a player character or group of player characters who control a game environment can issue stock or stock options in that game environment to player characters who want to play in that game environment. Players can post their player character history and receive stock or stock option offers from different game environments to play in them.

Player characters running each game environment could try to recruit the best group of players to form characters in their game environment so that they can build the wealth within that environment more quickly. Rather than game environments, player characters that govern cities, are the head of families or other groups, or run businesses in game environments could offer stock or stock options in the city or business to motivate a new player character to be a part of their city, business, or family.

A central server can charge a monthly fee to allow players to have characters in various game environments that are created and managed by other players. A portion of the monthly fee can be paid to the players managing a game environment based on the amount of time a player plays with characters in that game environment. Alternatively, a player can charge a daily fee for another player to have characters in his environment. A portion of the daily fee can be remitted to the central server in exchange for maintaining the game environment.

According to one embodiment, player characters and/or entire game environments that have created virtual and/or real value/wealth, may choose to offer stock in the game on a real stock exchange. Upon the issuance of actual stock in a real stock exchange, player characters would receive and/or have the option to receive real stock certificates/shares in proportion to their ownership of the virtual company as translated into real stock. Such translation may be on a one-to-one basis, or based upon each player character's prorate share of real to virtual shares, or any other method of conversion as agreed upon by the player characters that own such characters and/or game.

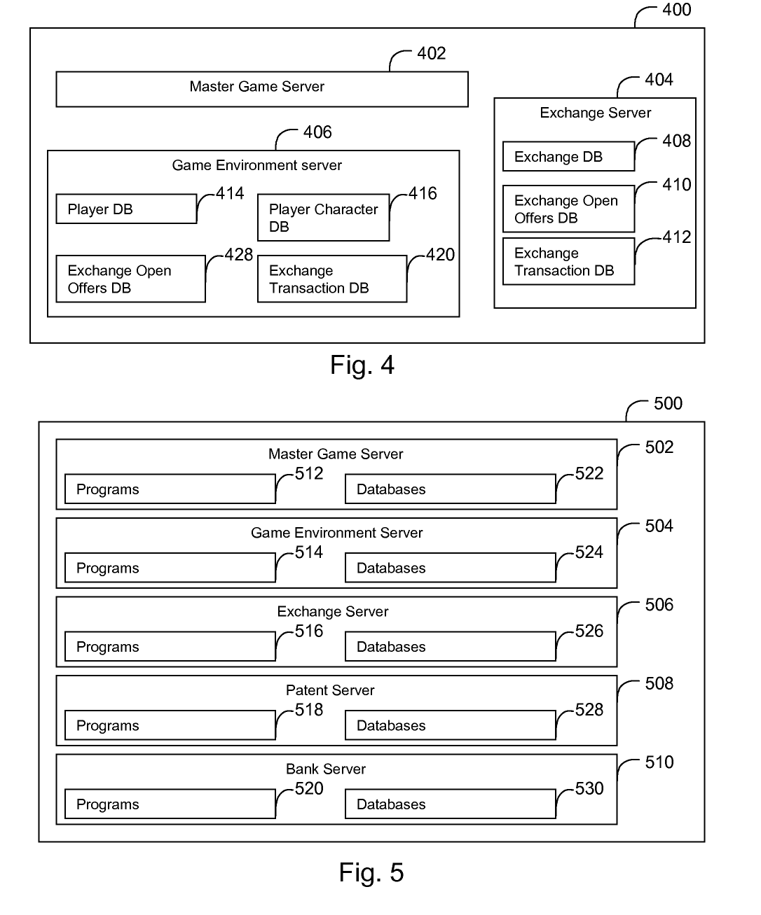

FIG. 4 provides an exemplary system 400 that may be used to provide the embodiment described above. As shown, system 400 may include a master game server 402, an exchange server 404, and an game environment server 406.

Exchange Server 404 may include or host various programs, routines, subroutines and/or databases including, but not limited to an exchange database 408, an exchange open offers database 410, and an exchange transaction database 412.

Exchange Database 408 may include information such as, but not limited to:

1. Exchange ID

2. Exchange Type

3. Exchange seats 1-n

4. Allowable assets 1-n

5. Exchange Seat Price

6. Maximum Exchange Seats allowed

7. Exchange Seats Issued

8. Remaining Exchange Seats available

9. Exchange Seat Price

10. Exchange Seat Qualifying conditions 1-n

Exchange Open Offers Database 410 may include information such as, but not limited to:

1. Offer ID

2. Offer Type

3. Offer posting Date

4. Offer expiration date

5. Offer Item

6. Offer QTY

7. Offer Price Exchange Transaction Database 412 may include information such as, but not limited to:

1. Order ID

2. Order Buyer

3. Order Seller

4. Order Date

5. Order Price

6. Order Type

7. Order terms and conditions

Game Environment Server may include or host various programs, routines, subroutines and/or databases including, but not limited to a player database 414, a player character database 416, an exchange open offers database 418, and an exchange transaction database 420.

Player Database 414 may include information such as, but not limited to:

1. Player ID

2. Player Billing Info

3. Player Personal Info

4. Player Exchange Seat ID

Player Character Database 416 may include information such as, but not limited to:

1. Character ID

2. Player ID

3. Character Assets

4. Exchange Seat Owner Account Number

5. Exchange Seat Number

Exchange Open Offers Database 418 may include information such as, but not limited to:

1. Offer ID

2. Offer Type

3. Offer posting Date

4. Offer expiration date

5. Offer Item

6. Offer QTY

7. Offer Price

Exchange Transaction Database 420 may include information such as, but not limited to:

1. Order ID

2. Order Buyer

3. Order Seller

4. Order Date

5. Order Price

6. Order Type

7. Order terms and conditions

System 400 may be configured to create an exchange by performing steps such as:
1. Receive a request to create an exchange, including the types of virtual assets to be traded on the exchange, the seats available on the exchange, the fee structure of the exchange, and the player character(s) who own the exchange
2. Determine if a permit is available to create the exchange
3. Generate and Output a permit price based on the exchange creation request
4. Receive an acceptance of the price
5. Create Exchange

System 400 may be configured to allow a player character to register a game environment on an exchange by performing steps such as:
1. Receive a request to register a game environment on the exchange
2. Determine if game environment qualifies to be registered on the exchange
3. Register game environment on exchange

System 400 may be configured to allow a player character to sell an exchange seat by performing steps such as:

1. Receive a request to purchase an exchange seat from a player character

2. Generate an exchange seat value

3. Output an exchange seat value to player character

4. Receive acceptance of exchange seat value from player character

5. Withdraw exchange seat value from player character account

6. Issue exchange seat to player character

System 400 may be configured to allow a player character to create an account with an exchange seat owner by performing steps such as:
1. Receive a request from a player character to create an account with an exchange seat owner
2. Determine account fee structure
3. Output fee structure to player character
4. Receive acceptance of fee structure
5. Create account

System 400 may be configured to allow a player character to purchase an item on an exchange with a margin account by performing steps such as:

Receive a request to purchase an item

Fill request to purchase an item

Withdraw virtual purchase price from account holder

If there are not enough funds to pay for item,

Determine if the account has a margin sub account

If the account has a margin sub account, withdraw funds from margin sub account

or

If the account does not have a margin sub account, retrieve credit card associated with player character account

Determine a real cash value for the virtual purchase price

Charge real cash value to credit card

Convert real cash value into virtual cash

Withdraw virtual cash from account

System 400 may be configured to allow a player character to sell an item on exchange by performing steps such as:
1. Receive a request from an account holder to sell a virtual asset, including a virtual item, a selling price, a warranty, and insurance
2. Determine if asset is authentic
3. Determine if the asset can be sold on the exchange based on the trade volume of that asset or similar items on the exchange
4. If item is authentic and trade volume permits, post asset for sale on exchange.
5. Receive purchase request for asset
6. Determine fees
7. Withdraw purchase price and fees from buyer
8. Transmit item to buyer
9. Transmit purchase price, less fees to seller

System 400 may be configured to determine the authenticity of an item by performing steps such as:
1. Receive a virtual asset to post on exchange
2. Determine if serial number of item is valid and that item descriptor matches descriptor of item described with that serial number
3. Determine if an asset is posted or has previously sold on any other exchange that has an identical blueprint and or serial number
4. If serial number is valid and no other items are posted or have been posted on an exchange, post item for sale on exchange.

System 400 may be configured to alter an item based on conversion rate after it is sold by performing steps such as:
1. Receive an indication that an item has been sold from one game environment to another
2. Determine conversion rate for item
3. Altering the item based on the conversion rate

System 400 may be configured to create a futures contract by performing steps such as:
1. Receive a request to buy or sell a fixed number of units of virtual asset at a specified later date for a specified unit price from a player character
2. Generate or Retrieve a per unit virtual cash futures contract price to fulfill the request
3. Output per unit virtual futures contract cash price to player character
4. Receive an acceptance of the futures contract price from the player character
5. Create a virtual futures contract, including the fixed number of units of the virtual asset, the specified unit price, the specified date, and the futures contract price.

System 400 may be configured to sell a futures contract by performing steps such as:
1. Receive a request to sell a futures contract from a first player character
2. Determine if date of contract has not expired
3. If date of contract has not expired, retrieve or generate a contract price
4. Output contract price to first player character
5. Receive acceptance of contract price from a second player character
6. Transfer contract to second player character and transfer contract price, less applicable fees, to first player character

According to yet another embodiment, the present invention provides for the Initial Public Offering (IPO) of Game Environments on an Inter-Game Environment Exchange. This embodiment allows players who have either paid for the privilege, come first, or reached a certain skill or wealth level, to purchase and manage their own game environment. Each game environment shares a server or resides on its own server or group of two or more servers and has a list of resources and points available to be attributed to each resource on the list. The player character assigns the points to various resources, which define the resources available for that particular game environment. The player character is then able to recruit other player characters to begin cities or other virtual environments in the game environment created. Those player characters can then recruit other player characters to be citizens in the cities. Player characters can build in-game objects from resources and game items created by other player characters. Game items may be registered with a central patent office as described in detail above and can only be created by one player character playing in a game environment. Game items, resources, and blueprints to create game items can be exchanged between game environments.

According to one embodiment, each player character can receive stock and/or stock options in the game environment. An IPO date can be set for each game environment on an intra server exchange. The value of the game environment may be based on the GDP of the game environment or any other means that measures the relative value or present or future value of the game environment.

According to one embodiment, player characters who earn the most wealth in a game environment can earn the right to buy and start a new game environment.

As stated above, according to one embodiment, game item designs can be registered with a central Patent office for all game environments and those item designs cannot be created again. Patents on designs in the game environments can expire just as they do in the real world so that some item designs are in the public domain after a certain time period. The virtual lifespan of a patent can be variable based on the era or age of the game environment. For instance, the blueprint of an item created in the first era of the game can have a longer virtual life than a blueprint created in a later era of the game.

In each game environment, a player character can view the designs of items registered with the patent office and purchase them to make game items. Player characters can use resources, skills, NPCs, and other game items to assemble new game items that can be sold on exchanges in the game environment and between other game environments.

According to one embodiment, a levy or tax may be given to the game environment owner on all transactions. The player character that owns the game environment can set a tax amount that other player characters must pay on all transactions done in the game environment. This tax amount could be the GDP that is used to determine the valuation of the IPO.

According to one embodiment, shares in game environments, businesses in game environments, and player characters can be sold to other player characters entering the game environments.

Non-limiting examples of items that can be configured by the owner of the game environment include:
1. Resources
2. Available Skills and Maximum Levels
3. Game Play Types
4. Taxes
5. Permits
6. Government Types
7. Exchange Types
8. Types of Businesses and Max number of each business type
9. Mission types and quantities along with allowed rewards
10. Magic spells
11. Missions can be invented and implemented in the game environments. They also can be exchanged between game environments
12. Blueprint licenses

According to one embodiment, the IPO of a game environment may be based on a pre-established time limit.

According to one embodiment, as a player creates characters in various online game environments, a virtual resume of his characters and their attributes may be created and stored. When petitioning to build a character in a game environment, a player can submit a virtual resume to one or more players who control the game environment. The monthly fee for playing the game, the number of virtual stock shares or options of the game environment, and other criteria may be determined based on a player's virtual resume. The player may then be allowed to enter the game environment under terms and conditions that are established wholly or in part by the credentials verified by his virtual resume.

According to one embodiment, the game environment takes a piece (or tax) of all virtual or real money that changes hands in the game. This tax has a real world dollar value, which can be used to determine an IPO value of the game environment

According to one embodiment, player characters create virtual assets in the game environment. When the game environment goes public, their assets in the game can be converted into shares of a virtual company.

According to one embodiment, player characters may be required to pay taxes to the game environment in which they are playing. They can specify what resources they want the game environment to purchase or obtain with the tax dollars.

According to one embodiment, a game environment can be sold to a player character for real cash, virtual cash, stocks, options, lines of credit or loans, or a mix of any or all of these in an upfront or ongoing amount. That Player Character can sell mayor seats for real cash, virtual cash, or a mix in an upfront or ongoing amount. Mayors can sell monthly play time in their cities for real cash, virtual cash, or a mix in an upfront or ongoing amount. The structure can set up as a pyramid system where a percentage of each player's monthly and or upfront fees flow up through various levels of the game parameter hierarchy. Each member of the hierarchy receives a specified percentage of the real cash virtual fee a player pays to have a character in the game environment as well as a percentage of the virtual assets created by that player character during play time in the game environment.

According to one embodiment, in the event of an IPO, the value of all the assets in a game environment may be determined. A number of shares to be sold may then be determined, and a value placed on them based on the assets of the game environment and/or the number of shares issued and outstanding and/or the total number and value of stock options and their strike prices, etc. The shares may be registered on an exchange where they can be purchased. The proceeds of the IPO may be given either to the owner(s) of the game environment or to the game environment account. Methods of establishing and operating a virtual exchange are described in greater detail above. Asset values can also be determined based on the exchange prices for those items on inter game environment exchanges.

According to one embodiment, when creating a game environment, a certain number of shares of that game environment may be created and issued by the game environment owner. Shares can also be allocated to cover stock options issued to other player characters. Shares can additionally be created when the virtual assets of the game environment are determined before an IPO.

According to one embodiment, a virtual asset in a game environment can be given a value based on a multiple of the asset's virtual cash value or on a multiple of the underlying natural resource that can be salvaged from the asset. Shares of the game environment can be issued in exchange for the assets by determining a share price. A share price could be determined by taking the virtual cash value of the assets in a game environment and summing them to determine total game environment value.

For example, the virtual cash value of all the assets of a given game environment could be $2,000,000. A stock multiplier of 2 may be applied to the value to determine that the game environment is worth $4,000,000. If 1,000,000 units of stock were initially issued to the player who owns the game environment, and 20,000 units of stock were set aside to cover options of player characters participating in the game environment, the 1,020,000 units of stock would be worth $3.92 per share. A player character in the game environment might own a sword that sells on an exchange for $250. At the time of IPO, the player character can either keep the sword or exchange it for shares of the game environment at a conversion rate of $3.92 per share, or 63.77 shares. If the player elects to exchange the sword for shares, the account of the game environment issues 63.77 shares to the player character and takes the sword into inventory.

If 27,000 shares of stock are exchanged for assets in the game environment and 100,000 units of stock are registered to be sold at the IPO for $3.92 per share, at the IPO, there would be 1,147,000 shares of the game environment in existence. The game environment would then have a virtual market value of $4,496,240 where the owner of the game environment has stock in the game environment worth $3,920,000, the new share holders own $392,000 worth of stock in the game environment, the stock option holders hold options to buy $78,400 worth of stock, player characters who owned assets in the game environment hold $105,840 of stock, and the treasury of the game environment holds $392,000 in virtual cash and $105,840 of virtual assets. The value of the stock could then fluctuate based on its market value on the exchange.

According to one embodiment, the number of game environments available can be limited based on the number of player characters playing, the market value of all game environments, or any other criteria.

According to one embodiment, player characters would have to pay a real cash up front and monthly fee to manage and own a game environment.

According to one embodiment, the rules and regulations controlling an in-game or multiple game exchange may be established by the game manufacturer and/or one or more duly authorized players and/or any duly authorized virtual government or other governing body and/or a user group and/or a consortium of game manufacturers and/or of game players or any combination of any of the forgoing and, which laws, rules and regulations may be based in part or in whole upon those laws, rules, regulations and precedence of those of the United States of America and/or the SEC, and/or the US Stock Exchange, and/or NASDAQ, and/or the American Stock Exchange, all of which laws, rules, regulations, and precedence's based upon US case law are hereby incorporated by reference in their entirety for all purposes.

According to one embodiment, player characters and/or entire game environments that have created virtual and/or real value/wealth, may choose to offer stock in the game on a real world stock exchange such as the NASDAQ. Upon the issuance of actual stock in a real stock exchange, player characters would receive and/or have the option to receive real stock certificates/shares in proportion to and/or in exchange for their ownership of the virtual company as translated into real stock. Such translation may be on a one-to-one basis, or based upon each player character's pro rated share of real to virtual shares, or any other method of conversion as agreed upon by the player characters that own such characters and/or game shares and/or as otherwise agreed to by the player characters and/or game manufacturers or any other duly appointed and authorized body to determine such valuation, and/or based upon a majority and/or super majority vote by all affected game players and/or only by those holding virtual shares and then only in proportion to their pro-rata share amounts and/or based upon their preexisting or subsequently established voting rights, which may be determined based upon their number of shares or based on the value of their shares and/or their exercise price for their options and the like. The expiration of a patent on a blueprint can be based on the date the blueprint was filed, or the date that a patent was issued for the blueprint

According to one embodiment, the monthly fee that a player pays to have a character in a game environment can be related to the transaction and tax fees that player pays when he conducts business in or between the game environments. For example, a player paying $20 a month could have no fees on transactions on game exchanges while a player paying $10 a month would have to pay 3% commission on all transactions conducted on an exchange.

According to one embodiment, the master server, game environment servers, patent office server, exchange server, and bank server can charge per transaction fees or taxes to all transactions between player characters. In the event an item is traded on an exchange, the exchange seat holders, the buyer, the seller, the game environment owners, and the game environment government can all charge and be charged a per transaction or percentage fee when an item is exchanged.

FIG. 5 provides an exemplary system 500 that may be used to provide the embodiment described above. As shown, system 500 may include a plurality of servers such as a master game server 502, game environment server 504, exchange server 506, patent server 508, and bank server 510.

Master Game Server 502 may manage the registration of all game environment servers, exchange servers, bank servers, and the patent server. The master game server may include or host various programs, routines, or subroutines 512 and databases 522 including, but not limited to:
1. Game Environment creation program
2. Game Environment management program
3. Game Environment IPO program
4. Game Environment Database, which may include information such as, but not limited to:
   a. Game Environment ID
   b. Player Owners 1-n
   c. Percentage Ownership 1-n
   d. Configuration Settings 1-n
   e. Creation Date
   f. IPO Date
   g. Monthly billing fee configuration
5. Allowed Exchange Database, which may include information such as, but not limited to:
   a. Maximum number of exchanges (by type) allowed
   b. Number of exchange (by type) issued
   c. Available exchanges by type
   d. Fee to open new exchange
6. Active Exchange Database, which may include information such as, but not limited to:
   a. Exchange ID
   b. Exchange Type
   c. Exchange Conditions
   d. Registered Exchange Seats
   e. Maximum Number of Exchange Seats
   f. Issued Exchange Seats
   g. Exchange Seats Available
7. Allowed Bank Database, which may include information such as, but not limited to:
   a. Maximum number of banks (by type) allowed
   b. Number of banks (by type) issued
   c. Available Banks (by type)
   d. Fee to open new bank
8. Active Bank Database, which may include information such as, but not limited to:
   a. Bank ID
   b. Bank Type
   c. Bank Rules and Conditions
   d. Registered bank owners
9. Player Database, which may include information such as, but not limited to:
   a. Player ID
   b. Player Characters 1-n
   c. Player Billing info
   d. Exchange Seats owned
   e. Exchanges owned 1-n
   f. Banks owned 1-n
10. Master Rules and Conditions Database, which may include information such as, but not limited to:
   a. Game Environment Rules and Conditions Parameters 1-n
   b. Exchange Condition Rules and Parameters 1-n
11. Bank Condition Rules and Parameters 1-n

Game Environment Server 504 may include one or more servers that are controlled by players and are configured manage gameplay based on rules and conditions set by the players and registered with the master game server. The game environment server may include or host various programs, routines, or subroutines 514 and databases 524 including, but not limited to:
1. Game Environment set up program
2. Game Environment Management Program
3. Game Environment IPO Program
4. Player Database, which may include information such as, but not limited to:
   a. Player ID
   b. Player Characters 1-n
   c. Billing Configuration 1-n
   d. Billing information
   e. Personal information
   f. Player assets 1-n
5. Raw Material Database, which may include information such as, but not limited to:
   a. Raw Material ID
   b. Type
   c. Location
   d. First Date Available
   e. Conditions for use
   f. Conditions for discovery
   g. Conditions for availability
   h. Max Quantity Allowed
   i. Quantity Issued
   j. Quantity Remaining
   k. License or Permit Fee
   l. Available Era(s)
6. NPC Database, which may include information such as, but not limited to:
   a. NPC ID
   b. Type
   c. Location
   d. Conditions for Use
   e. Conditions for availability
   f. Max Quantity Allowed
   g. Quantity Issued
   h. Quantity Remaining
   i. License or Permit Fee
   j. Available Era(s)
7. Skill Database which may include information such as, but not limited to:
   a. Skill ID
   b. Type
   c. Conditions for Use
   d. Conditions for Availability
   e. Max Quantity Allowed
   f. Quantity Issued
   g. Quantity Remaining
   h. License or Permit Fee
   i. Available Era(s)
8. Era Database which may include information such as, but not limited to:
   a. Era ID
   b. Date Range
9. Exchange Multiplier Database which may include information such as, but not limited to:
   a. Exchange ID
   b. Multiplier Number
10. Player Database which may include information such as, but not limited to:
   a. Player ID
   b. Characters 1-n
   c. Billing Information
   d. Personal Information
11. Player Character Database which may include information such as, but not limited to:
   a. Character ID
   b. Player ID
   c. Assets 1-n
   d. Skills 1-n
   e. Obligations 1-n
12. Rules and Conditions Database which may include information such as, but not limited to:
   a. Rule ID
   b. Rule Descriptor
   c. Rule Type
13. Fee structure database which may include information such as, but not limited to:
   a. Fee ID
   b. Fee Structure
   c. Fee Type
   d. Fee Amount

Exchange Server 506 may include one or more servers configured to facilitate the exchange of virtual assets between game environments. The exchange server may include or host various programs, routines, or subroutines 516 and databases 526 including, but not limited to:
1. IPO Program

### Exchange Program

2. Exchange Database which may include information such as, but not limited to:
   a. Exchange ID
   b. Exchange Type
   c. Exchange seats 1-n
   d. Allowable assets 1-n
   e. Exchange Seat Price
   f. Maximum Exchange Seats allowed
   g. Exchange Seats Issued
   h. Remaining Exchange Seats available
   i. Exchange Seat Price
   j. Exchange Seat Qualifying conditions 1-n
3. Exchange Open Offers Database which may include information such as, but not limited to:
   a. Offer ID
   b. Offer Type
   c. Offer posting Date
   d. Offer expiration date
   e. Offer Item
   f. Offer QTY
   g. Offer Price
4. Exchange Transaction Database which may include information such as, but not limited to:
   a. Order ID
   b. Order Buyer
   c. Order Seller
   d. Order Date
   e. Order Price
   f. Order Type
   g. Order terms and conditions
5. Exchange Seat Database which may include information such as, but not limited to:
   a. Exchange Seat ID
   b. Player ID
   c. Exchange Seat Type
   d. Exchange ID
6. Exchange Seat Account Database which may include information such as, but not limited to:
   a. Account Id
   b. Character ID
   c. Fee Configuration
   d. Account Transaction History
   e. Account Assets 1-n

Patent Server 508 may act as the central system to receive item blueprints, issue patents on blueprints, and manage patented item blueprints. Patent server 508 may include or host various programs, routines, or subroutines 518 and databases 528 including, but not limited to:
1. File Blueprint Program
2. Register Blueprint Program
3. Expire Blueprint Program
4. Registered Blueprint Database
   a. Blueprint ID
   b. Blueprint Inventor
   c. Blueprint Assignee
   d. Blueprint Class
   e. Blueprint Subclass
   f. Blueprint Status
   g. Blueprint Content
   h. Skills Required to assemble item from blueprint
   i. Blueprints required to assemble blueprint
   j. Resources required to assemble blueprint
   k. Blueprint Registration Date
   l. Blueprint Royalty Configuration
   m. Examiner ID
   n. Max quantity
   o. Quantity remaining
   p. Quantity sold
   q. Expiration Date
   r. Expiration Quantity
5. Examiner Database
   a. Examiner ID
   b. Examiner Class
   c. Examiner Subclass
   d. Examination History

Bank Server 510, may include one or more servers configured to manage the player and player character virtual cash accounts. Bank server 510 may include or host various programs, routines, or subroutines 18 and databases 530 including, but not limited to:
1. account management program
2. Account Database which may include information such as, but not limited to:
   a. Account ID
   b. Character ID
   c. Account Balance
   d. Account Transaction History
3. Loan Database which may include information such as, but not limited to:
   a. Loan Id
   b. Loan Origination Date
   c. Loan terms and conditions
   d. Loan Payment Schedule
   e. Loan Payment History

System 500 may be configured to create the rules of a game environment by performing steps such as:
1. providing a master server that is configured to
   a. Receive a request from a player to create a game environment including a game environment type, and a monthly fee offer (if applicable)
   b. Determine if player is eligible to form game environment
   c. If player is eligible, determine an upfront and monthly fee for the game environment based on the player resume and fee determining conditions
   d. Output offer to provide game environment
   e. Receive acceptance of offer
   f. Assemble and Provide Game Environment
   g. Charge up front fee to player account
   h. Receive rules and condition configuration from player for game environment
   i. Store game environment rules and conditions
2. providing a game environment configured to
   a. Output a request to configure rules and conditions to player
   b. Receive rule and request configuration
   c. Store configuration and transmit to Master Server
   d. Activate Game Environment based on rule and condition configuration.

System 500 may be configured to issue stock options in a game environment to player characters by performing steps such as:
1. Receive a request from a player to create one or more characters in a game environment including a player resume associated with the player character
2. Determine a stock or stock option offer based on the player character resume
3. Output offer to player
4. Receive acceptance of offer
5. Create character account, including options offer.

System 500 may be configured to recruit other players to play in the Game Environment by performing steps such as:
1. Receive a request to recruit player characters into a game environment, including resume criteria and stock or stock option offers based on resume criteria
2. Generate a list of players that fall within resume criteria settings
3. Output stock or stock option contract offers to players based on resume criteria
4. Receive acceptance of offer(s)
5. Create new player accounts in game environment including stock or stock option contracts

System 500 may be configured to exchange Items between game Environments by performing steps such as:
1. Receive an offer to buy or sell a virtual item on virtual exchange from a first player who owns a virtual exchange seat
2. Determine if item is unique
3. Post offer on virtual exchange
4. Receive acceptance of offer from a second player who owns a virtual exchange seat
5. Determine game environment multiplier based on game environments represented by first and second player character
6. Alter virtual item based on multiplier
7. Transmit item to second player
8. Transmit payment for item from second player to first player, less exchange fee

System 500 may be configured to create an initial public offering of a game environment based on time by performing steps such as:
1. Determine that enough virtual or real time has lapsed that a game environment must be taken public
2. Determine a share price based on virtual assets of game environment
3. Notify player characters of game environment of share price
4. Receive virtual asset to share requests from player characters in game environment
5. Exchange virtual assets to virtual shares based on share requests and rules and conditions
6. Output announcement that game environment will IPO
7. Post IPO shares of game environment on virtual stock exchange at determined IPO share price

System 500 may be configured to create an initial public offering of a game environment based on the asset value of the game environment by performing steps such as:

1. Determine Virtual Asset Value of Game Environment

2. Determine that asset value requires IPO

3. Output announcement that game environment will IPO

4. Post IPO shares of game environment on virtual stock exchange

System 500 may be configured to allow a player character to become eligible to create a game environment by performing steps such as:
1. Retrieve a player resume
2. Determine if resume qualifies to create a game environment based on qualification rules and conditions
3. Flag resume as qualifying and output notice to player character that he is eligible to create and manage a game environment

System 500 may be configured to determine the percentage ownership of shares of a player character based on asset value by performing steps such as:
1. Determine a total virtual asset value for a game environment based on virtual assets and valuation rules and conditions
2. Generate a percentage ownership of the total virtual asset value for each player character based on the virtual assets of the game environment they own
3. Convert virtual asset ownership into share ownership of the game environment for each player character
4. Notify player character of asset conversion

System 500 may be configured to create a virtual item blueprint by performing steps such as:
1. Receive a virtual item blueprint including: the size, shape, virtual resources, virtual materials, and virtual items necessary to create an item
2. Determine skills necessary to assemble item based on blueprint specifications
3. Store blueprint with skills required to assemble and item from the blueprint.

System 500 may be configured to allow a player character to register a blueprint with a patent office by performing steps such as:
1. Receive a request to register a blueprint, including blueprint specifications, a field of use, a player character inventor, a virtual fee to use a blueprint to assemble and item, and a creation date
2. Generate a list of existing registered blueprints that are similar to the blueprint
3. Determine if blueprint is too similar to existing blueprints.
4. If blueprint is too similar, output similar blueprints and blueprint to patent examiner player character for review
5. Receive opinion from patent examiner player character that blueprint is unique
6. Create blueprint registration number
7. Issue patent on blueprint Or
8. If blueprint is not too similar
9. Create blueprint registration number
10. Issue patent on blueprint
11. System 500 may be configured to Patent Expiration
1. Determine that a patent on a blueprint has reached its expiration date
1. Expire patent
14. Notify patent holder and licensees that patent has expired.

System 500 may be configured to charge royalties for blueprint use by performing steps such as:
1. Receive a request to assemble an item from a blueprint from a player
2. Generate or retrieve a fee to assemble an item from a blueprint
3. Output fee
4. Receive acceptance of fee
5. Issue one time use virtual blueprint to player.
6. Receive indication that blueprint has been used
7. Charge usage fee to player
8. Transmit fee, less applicable commission, to the account of the player character who owns a patent on the blueprint

System 500 may be configured to charge taxes on exchange transactions by performing steps such as:
1. Receive an indication that an item has been exchanged from one game environment to another
2. Determine a tax fee based on rules and conditions
3. Apply tax fee to transaction

System 500 may be configured to allow a player character to create a virtual resume by performing steps such as:

1. Receive a play log of a character associated with a player

2. Store log with player profile

3. Establish resume credentials based on log

4. Store credentials with resume

System 500 may be configured to review a virtual resume to allow for character creation by performing steps such as:
1. Receive a request to create a character in a game environment from a player
2. Retrieve resume of player
3. Determine character settings based on resume and game environment, including player starting skills, residence, family, game environment stock option quantity, game environment stock option strike price, game environment stock, virtual loan amount, virtual loan interest, entry experience level, etc.
4. Output settings
5. Receive acceptance of settings
6. Create character for player in game environment

System 500 may be configured to allow a player character to exercise stock options by performing steps such as:
1. Receive a request to exercise a virtual stock option of a game environment
2. Determine if request is possible based on exercise conditions
3. If request is possible, determine a virtual cash amount due based on exercise price of option.
4. Output amount due
5. Receive payment of amount due
6. Release stock of game environment to player character
7. Flag option as exercised.

System 500 may be configured to allow a player character to exchange assets for shares of a game environment before an initial public offering by performing steps such as:
1. Output a virtual IPO cash price of a share of a game environment to a player character
2. Receive a request to exchange an asset for shares from a player character in the game environment
3. Determine the asset value
4. Receive the asset into the game environment account
5. Transfer stock whose virtual cash value is equal to the virtual cash value of the asset to the player character

The present disclosure provides numerous systems and methods related to virtual environments in online computer games. It should be appreciated that numerous embodiments are described in detail and that various combinations and subcombinations of these embodiments are contemplated by the present disclosure.

1. A virtual environment comprising:
a digital work editor configured to allow a player character to create a digital work in the virtual environment; and
a virtual copyright office configured to register the digital works.

2. The virtual environment of claim 1 further comprising a copyright examination module configured to receive a sample of the digital work and determine if the digital work is a unique work.

3. The virtual environment of claim 1 further comprising an exchange configured to a allow player characters to buy, sell, or trade the digital works in the virtual environment.

4. The virtual environment of claim 3 further comprising a digital works pricing module configured to determine a pricing scheme for a digital work listed on the exchange.

5. The virtual environment of claim 1 further comprising a subscription service configured to allow player characters to access a digital work and use the work in a virtual space.

6. The virtual environment of claim 5 further comprising a usage tracking module configured to track the number of player characters that access the digital work.

7. The virtual environment of claim 6 further comprising a billing module configured to bill a player character for accessing the digital work.

8. A method comprising:
providing a virtual environment;
providing access to a digital work editor via the virtual environment so that an author can create a digital work that will be accessible in the virtual environment; and
ensuring that the author receives compensation from player characters that access the digital work in the virtual environment.

8. (canceled)

9. The method of claim 8 wherein ensuring that the author receives compensation from player characters that access the digital work in the virtual environment comprises providing a virtual copyright office configured to:
receive a copyright application for a digital work; and
examine the application to determine if the digital work is unique in the virtual environment.

10. The method of claim 9 wherein the copyright office is further configured to award a copyright to the author of the digital work, if the digital work is unique in the virtual environment.

11. The method of claim 7 further comprising:
receiving a request from a player character to use a digital work that already exists in the virtual environment;
determining if the digital work is subject to a copyright.

12. The method of claim 11, wherein if the digital work is subject to a copyright, the method further comprises:
identifying an owner of the copyright;
requesting the copyright owner's permission to use the copyright; and
if the copyright owner's permission is granted, allowing the player character to use the digital work.

13. The method of claim 11, wherein if the digital work is subject to a copyright, the method further comprises:
determining a pricing scheme for use of the digital work;
receiving compensation from the player character for use of the digital work; and
providing compensation to the copyright owner.

14. The method of claim 13 wherein determining a pricing scheme for use of the digital work comprises identifying the virtual space in which the digital work will be used.

15. The method of claim 13 wherein determining a pricing scheme for the digital work comprises identifying the average number of player characters that will have access to the digital work where it is to be used.

16. The method of claim 13 wherein determining a pricing scheme for the digital work comprises determining a royalty scheme based on the number of unique impressions by the player character using the digital work.

17. The method of claim 13 wherein determining a pricing scheme for the digital work comprises identifying a flat fee.

18. The method of claim 13 wherein determining a pricing scheme for the digital work comprises receiving a price from the copyright owner.

19. The method of claim 10 further comprising providing an exchange configured to allow player characters to buy, sell, or trade copyrighted digital works.

20. The method of claim 10 further comprising providing an exchange configured to allow player character to buy, sell, or trade copyright ownership of digital works.
